(19) United States
(12) Patent Application Publication
(10) Pub. No.: US 2025/0030000 A1
(43) Pub. Date: Jan. 23, 2025

(54) LITHIUM CARBON COMPOSITE BATTERY

(71) Applicant: GROUP14 TECHNOLOGIES, INC., Woodinville, WA (US)

(72) Inventors: Nathan D. PHILLIP, Poulsbo, WA (US); Avery J. SAKSHAUG, Snohomish, WA (US); Rajankumar PATEL, Pasco, WA (US); Abirami DHANABALAN, Bothell, WA (US); Christopher TIMMONS, Monroe, WA (US); Aaron M. FEAVER, Seattle, WA (US); Henry R. COSTANTINO, Woodinville, WA (US)

(21) Appl. No.: 18/711,025

(22) PCT Filed: Nov. 17, 2022
(86) PCT No.: PCT/US2022/080075

§ 371 Date: May 16, 2024

Related U.S. Application Data
(60) Provisional application No. 63/280,491, filed on Nov. 17, 2021.

(51) Int. Cl. H01M 4/587; H01M 4/02; H01M 4/04; H01M 4/36; H01M 4/62; H01M 10/052

(52) U.S. Cl. CPC H01M 4/587; H01M 4/0404; H01M 4/362; H01M 4/622; H01M 4/625; H01M 10/052; H01M 2004/021

(57) ABSTRACT

Disclosed herein are particulate lithium carbon composite materials and devices containing the same.

### BACKGROUND

### Technical Field

Embodiments of the present disclosure generally relate to composite particles comprising Group14 elements, e.g., carbon, and lithium, and electrodes and lithium carbon battery devices comprising the same. These materials are produced via novel processes that provide for a lithium within the pores of porous carbon particles to yield the final lithium-carbon composite particles. Suitable carbon precursors include, but are not limited to, sugars and polyols, organic acids, phenolic compounds, cross-linkers, and amine compounds, and combinations thereof. The lithium impregnated into the carbon porous can be provided as lithium, or alternatively, lithium salts, or other lithium-containing species can serve as the precursor for lithium within the lithium-carbon composite. Suitable porous scaffolds include, but are not limited to, porous carbon scaffolds, for example carbon having a pore volume comprising micropores (less than 2 nm), mesopores (2 to 50 nm), and/or macropores (greater than 50 nm).

### Description of the Related Art

Lithium is a potentially useful anode material due to its high specific capacity (3900 mAh/g), low redox potential (−3.04 V), and ability to provide for the entirety of the battery lithium supply, e.g., enable battery chemistries with lithium-free cathode materials. However, the practical application of lithium metal anodes is still prohibited by its low Coulombic efficiency (CE) and growth of lithium dendrites during lithium dissolution/deposition. This propensity for lithium striping and plating degrades battery performance, resulting in limited cycle life and severe safety issues that impede the practical application of batteries with lithium metal in the anode.

In order to solve these issues, there has been some limited progress in the prior art by attempting to combine lithium with a carbon-based material. For example, it was reported that a lithium-carbon nanotube microsphere composite with a hydrophobic self-assembled monolayer surface passivation layer could provide for a battery wherein the CE increased from the typical value of 0.990 or lower to about 0.993 in the presence of dual-salt electrolyte system of LiPF6 and LiNO3 (“Stable Lithium-Carbon Composite Enabled by Dual-Salt Additives,” L. Zheng et al., Nano-Micro Letters, Volume 13, Article 111, 2021). Such an approach as described in the prior art does not provide sufficient CE to provide for the cycle life requirement for most practical battery applications.

### BRIEF SUMMARY

Disclosed herein are compositions and manufacturing methods related to lithium-carbon composite materials, and electrodes and battery comprising the same. The lithium-carbon composite material may be particulate, for example produced by creation of porous carbon scaffold particles, and subsequent impregnation of lithium into one or more pores of the porous carbon scaffold particles. To this end, the lithium impregnation can be achieved by various approaches including, but not limited to, melt intrusion, electrochemical deposition, lithium alloy formation, electrode reduction, chemical reduction, lithium evaporation, or combinations thereof. In some embodiments, the lithium-carbon composite particle may comprise an outer layer comprised of carbon or other inorganic species. In some embodiments, the lithium-carbon composite is produced by thermal treatment of a mixture of carbon and lithium precursor materials.

The domain size of the impregnated lithium may vary, for example, the impregnated lithium domain may reflect the size of the pores of the porous carbon scaffold, for example may be in the range of less than 2 nm, or 2 to 50 nm, or greater than 50 nm, or combinations thereof. The porous carbon scaffold can be a particulate porous carbon, and the average particle size can be in the range of 100 nm to 100 um.

A key advantage of impregnation of lithium into the pore of the porous carbon scaffold is that the carbon provides nucleation sites for impregnating lithium while dictating maximum particle shape and size. An additional advantage of impregnation of lithium into the pore of the porous carbon scaffold is that the composite particle may retain residual intra-particle void that may provide for further electrochemical benefits for the lithium-carbon composite anode material as disclosed herein. Yet another advantage of confining the growth of lithium in the anode within a nano-porous structure is reduced susceptibility to lithium dendrite formation or plating. Moreover, the lithium-carbon composite structure promotes nano-sized lithium in the anode to retain lithium as an amorphous phase.

Such properties provide for improved CE and improved cycle stability in combination with high charge/discharge rates, particularly in combination with lithium's vicinity within the conductive carbon scaffold. This system provides a high-rate-capable, solid-state lithium diffusion pathway that enables safe battery cycling.

Such lithium-carbon composite materials as disclosed herein have utility as battery materials, for example as anode active materials for conventional or solid-state lithium-ion batteries, cathode active materials for next-generation battery configurations such as lithium air, and hybrid anode/cathode active materials for symmetric cell format batteries. Such lithium-carbon composite materials as disclosed herein have utility as battery materials specifically as the key anode material in a lithium carbon battery. Herein a lithium carbon battery is defined as a battery comprising an anode comprising a lithium carbon composite.

### BRIEF DESCRIPTION OF THE DRAWINGS

FIG. 1 shows a schematic of particle comprising lithium-carbon composite material.

### DETAILED DESCRIPTION

In the following description, certain specific details are set forth in order to provide a thorough understanding of various embodiments. However, one skilled in the art will understand that the disclosure may be practiced without these details. In other instances, well-known structures have not been shown or described in detail to avoid unnecessarily obscuring descriptions of the embodiments. Unless the context requires otherwise, throughout the specification and claims which follow, the word “comprise” and variations thereof, such as, “comprises” and “comprising” are to be construed in an open, inclusive sense, that is, as “including, but not limited to.” Further, headings provided herein are for convenience only and do not interpret the scope or meaning of the claimed disclosure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Also, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

### A. Porous Scaffold Materials

For the purposes of embodiments of the current disclosure, a porous scaffold may be used, into which lithium is to be impregnated. In this context, the porous scaffold can comprise various materials. In some embodiments the porous scaffold material primarily comprises carbon, for example hard carbon. Other allotropes of carbon are also envisioned in other embodiments, for example, graphite, amorphous carbon, diamond, C60, carbon nanotubes (e.g., single and/or multi-walled), graphene and/or carbon fibers. The introduction of porosity into the carbon material can be achieved by a variety of means. For instance, the porosity in the carbon material can be achieved by modulation of polymer precursors, and/or processing conditions to create said porous carbon material, and described in detail in the subsequent section.

In other embodiments, the porous scaffold comprises a polymer material. To this end, a wide variety of polymers are envisioned in various embodiments to have utility, including, but not limited to, inorganic polymers, organic polymers, and additional polymers. Examples of organic polymers includes, but are not limited to, sulfur-containing polymers such polysulfides and polysulfones, low density polyethylene (LDPE), high density polyethylene (HDPE), polypropylene (PP), polyvinyl chloride (PVC), polystyrene (PS), nylon, nylon 6, nylon 6,6, teflon (Polytetrafluoroethylene), thermoplastic polyurethanes (TPU), polyureas, poly(lactide), poly(glycolide) and combinations thereof, phenolic resins, polyamides, polyaramids, polyethylene terephthalate, polychloroprene, polyacrylonitrile, polyaniline, polyimide, poly(3,4-ethylenedioxythiophene) polystyrene sulfonate (PDOT: PSS), polymerized polydivinylbenzene, and others known in the arts. The organic polymer can be synthetic or natural in origin. In some embodiments, the polymer is a polysaccharide, such as sucrose, starch, cellulose, cellobiose, amylose, amylopectin, gum Arabic, lignin, and the like. In some embodiments, the polysaccharide is derived from the caramelization of mono- or oligomeric sugars, such as fructose, glucose, sucrose, maltose, raffinose, and the like.

In certain embodiments, the porous scaffold polymer material comprises a coordination polymer. Coordination polymers in this context include, but are not limited to, metal organic frameworks (MOFs). Techniques for production of MOFs, as well as exemplary species of MOFs, are known and described in the art (“The Chemistry and Applications of Metal-Organic Frameworks, Hiroyasu Furukawa et al. Science 341, (2013); DOI: 10.1126/science. 1230444). Examples of MOFs in the context include, but are not limited to, Basolite™ materials and zeolitic imidazolate frameworks (ZIFs).

Concomitant with the myriad variety of polymers envisioned with the potential to provide a porous substrate, various processing approaches are envisioned in various embodiments to achieve said porosity. In this context, general methods for imparting porosity into various materials are myriad, as known in the art, including, but certainly not limited to, methods involving emulsification, micelle creation, gasification, dissolution followed by solvent removal (for example, lyophilization), axial compaction and sintering, gravity sintering, powder rolling and sintering, isostatic compaction and sintering, metal spraying, metal coating and sintering, metal injection molding and sintering, and the like. Other approaches to create a porous polymeric material, including creation of a porous gel, such as a freeze dried gel, aerogel, and the like are also envisioned.

In certain embodiments, the porous scaffold material comprises a porous ceramic material. In certain embodiments, the porous scaffold material comprises a porous ceramic foam. In this context, general methods for imparting porosity into ceramic materials are varied, as known in the art, including, but certainly not limited to, creation of porous In this context, general methods and materials suitable for comprising the porous ceramic include, but are not limited to, porous aluminum oxide, porous zirconia toughened alumina, porous partially stabilized zirconia, porous alumina, porous sintered silicon carbide, sintered silicon nitride, porous cordierite, porous zirconium oxide, clay-bound silicon carbide, and the like.

In certain embodiments, the porous material comprises a porous metal. Suitable metals in this regard include, but are not limited to porous aluminum, porous steel, porous nickel, porous Inconcel, porous Hastelloy, porous titanium, porous copper, porous brass, porous gold, porous silver, porous germanium, and other metals capable of being formed into porous structures, as known in the art. In some embodiments, the porous scaffold material comprises a porous metal foam. The types of metals and methods to manufacture related to the same are known in the art. Such methods include, but are not limited to, casting (including foaming, infiltration, and lost-foam casting), deposition (chemical and physical), gas-eutectic formation, and powder metallurgy techniques (such as powder sintering, compaction in the presence of a foaming agent, and fiber metallurgy techniques).

### B. Porous Carbon Scaffold Materials

Methods for preparing porous carbon materials from polymer precursors are known in the art. For example, methods for preparation of carbon materials are described in U.S. Pat. Nos. 7,723,262, 8,293,818, 8,404,384, 8,654,507, 8,916,296, 9,269,502, 10,590,277, and U.S. patent application Ser. No. 16/745,197, the full disclosures of which are hereby incorporated by reference in their entireties for all purposes.

Accordingly, in one embodiment the present disclosure provides a method for preparing any of the carbon materials or polymer gels described above. The carbon materials may be synthesized through pyrolysis of either a single precursor, for example a saccharide material such as sucrose, fructose, glucose, dextrin, maltodextrin, starch, amylopectin, amylose, lignin, gum Arabic, and other saccharides known in the art, and combinations thereof. Alternatively, the carbon materials may be synthesized through pyrolysis of a complex resin, for instance formed using a sol-gel method using polymer precursors such as phenol, resorcinol, bisphenol A, urea, melamine, and other suitable compounds known in the art, and combinations thereof, in a suitable solvent such as water, ethanol, methanol, and other solvents known in the art, and combinations thereof, with cross-linking agents such as formaldehyde, hexamethylenetetramine, furfural, and other cross-linking agents known in the art, and combinations thereof. The resin may be acid or basic, and may contain a catalyst. The catalyst may be volatile or non-volatile. The pyrolysis temperature and dwell time can vary as known in the art.

In some embodiments, the methods comprise preparation of a polymer gel by a sol gel process, condensation process or crosslinking process involving monomer precursor(s) and a crosslinking agent, two existing polymers and a crosslinking agent or a single polymer and a crosslinking agent, followed by pyrolysis of the polymer gel. The polymer gel may be dried (e.g., freeze dried) prior to pyrolysis; however drying is not necessarily required.

The target carbon properties can be derived from a variety of polymer chemistries provided the polymerization reaction produces a resin/polymer with the necessary carbon backbone. Different polymer families include novolacs, resoles, acrylates, styrenes, urethanes, rubbers (neoprenes, styrene-butadienes, etc.), nylons, etc. The preparation of any of these polymer resins can occur via a number of different processes including sol gel, emulsion/suspension, solid state, solution state, melt state, etc. for either polymerization and crosslinking processes.

In some embodiments the reactant comprises phosphorus. In certain other embodiments, the phosphorus is in the form of phosphoric acid. In certain other embodiments, the phosphorus can be in the form of a salt, wherein the anion of the salt comprises one or more phosphate, phosphite, phosphide, hydrogen phosphate, dihydrogen phosphate, hexafluorophosphate, hypophosphite, polyphosphate, or pyrophosphate ions, or combinations thereof. In certain other embodiments, the phosphorus can be in the form of a salt, wherein the cation of the salt comprises one or more phosphonium ions. The non-phosphate containing anion or cation pair for any of the above embodiments can be chosen for those known and described in the art. In the context, exemplary cations to pair with phosphate-containing anions include, but are not limited to, ammonium, tetraethylammonium, and tetramethylammonium ions. In the context, exemplary anions to pair with phosphate-containing cations include, but are not limited to, carbonate, dicarbonate, and acetate ions.

In some embodiments, the reactant comprises sulfur. In certain other embodiments, the sulfur is in the form of sulfuric acid. In certain other embodiments, the sulfur can be in the form of a salt, wherein the anion of the salt comprises one or more sulfate, sulfite, bisulfide, bisulfite, hypothiocyanite, sulfonium, S-methylmethionine, thiocarbonate, thiocyanate, thiophosphate, thiosilicate, or trimethylsulfonium, or combinations thereof.

In some embodiments, the catalyst comprises a basic volatile catalyst. For example, in one embodiment, the basic volatile catalyst comprises ammonium carbonate, ammonium bicarbonate, ammonium acetate, ammonium hydroxide, or combinations thereof. In a further embodiment, the basic volatile catalyst is ammonium carbonate. In another further embodiment, the basic volatile catalyst is ammonium acetate.

In still other embodiments, the method comprises admixing an acid. In certain embodiments, the acid is a solid at room temperature and pressure. In some embodiments, the acid is a liquid at room temperature and pressure. In some embodiments, the acid is a liquid at room temperature and pressure that does not provide dissolution of one or more of the other polymer precursors.

In one embodiment a spherical polydivinylbencene spheres are produced by precipitation polymerization, pyrolyzed, and activated by the methods described herein.

In certain embodiments, the polymer precursor components are blended together and subsequently held for a time and at a temperature sufficient to achieve polymerization. One or more of the polymer precursor components can have particle size less than about 20 mm in size, for example less than 10 mm, for example less than 7 mm, for example, less than 5 mm, for example less than 2 mm, for example less than 1 mm, for example less than 100 microns, for example less than 10 microns. In some embodiments, the particle size of one or more of the polymer precursor components is reduced during the blending process.

The blending of one or more polymer precursor components in the absence of solvent can be accomplished by methods described in the art, for example ball milling, jet milling, Fritsch milling, planetary mixing, and other mixing methodologies for mixing or blending solid particles while controlling the process conditions (e.g., temperature). The mixing or blending process can be accomplished before, during, and/or after (or combinations thereof) incubation at the reaction temperature.

Reaction parameters include aging the blended mixture at a temperature and for a time sufficient for the one or more polymer precursors to react with each other and form a polymer. In this respect, suitable aging temperature ranges from about room temperature to temperatures at or near the melting point of one or more of the polymer precursors. In some embodiments, suitable aging temperature ranges from about room temperature to temperatures at or near the glass transition temperature of one or more of the polymer precursors. For example, in some embodiments the solvent free mixture is aged at temperatures from about 20° C. to about 600° C., for example about 20° C. to about 500° C., for example about 20° C. to about 400° C., for example about 20° C. to about 300° C., for example about 20° C. to about 200° C. In certain embodiments, the solvent free mixture is aged at temperatures from about 50 to about 250° C.

The reaction duration is generally sufficient to allow the polymer precursors to react and form a polymer, for example the mixture may be aged anywhere from 1 hour to 48 hours, or more or less depending on the desired result. Typical embodiments include aging for a period of time ranging from about 2 hours to about 48 hours, for example in some embodiments aging comprises about 12 hours and in other embodiments aging comprises about 4-8 hours (e.g., about 6 hours).

In certain embodiments, an electrochemical modifier is incorporated during the above described polymerization process. For example, in some embodiments, an electrochemical modifier in the form of metal particles, metal paste, metal salt, metal oxide or molten metal can be dissolved or suspended into the mixture from which the gel resin is produced.

Exemplary electrochemical modifiers for producing composite materials may fall into one or more than one of the chemical classifications. In some embodiments, the electrochemical modifier is a lithium salt, for example, but not limited to, lithium fluoride, lithium chloride, lithium carbonate, lithium hydroxide, lithium benzoate, lithium bromide, lithium formate, lithium hexafluorophosphate, lithium iodate, lithium iodide, lithium perchlorate, lithium phosphate, lithium sulfate, lithium tetraborate, lithium tetrafluoroborate, and combinations thereof.

In certain embodiments, the electrochemical modifier comprises a metal, and exemplary species includes, but are not limited to aluminum isopropoxide, manganese acetate, nickel acetate, iron acetate, tin chloride, silicon chloride, and combinations thereof. In certain embodiments, the electrochemical modifier is a phosphate compound, including but not limited to phytic acid, phosphoric acid, ammonium dihydrogen phosphate, and combinations thereof. In certain embodiments, the electrochemical modifier comprises silicon, and exemplary species includes, but are not limited to silicon powders, silicon nanotubes, polycrystalline silicon, nanocrystalline silicon, amorphous silicon, porous silicon, nano sized silicon, nano-featured silicon, nano-sized and nano-featured silicon, silicyne, and black silicon, and combinations thereof.

Electrochemical modifiers can be combined with a variety of polymer systems through either physical mixing or chemical reactions with latent (or secondary) polymer functionality. Examples of latent polymer functionality include, but are not limited to, epoxide groups, unsaturation (double and triple bonds), acid groups, alcohol groups, amine groups, basic groups. Crosslinking with latent functionality can occur via heteroatoms (e.g. vulcanization with sulfur, acid/base/ring opening reactions with phosphoric acid), reactions with organic acids or bases (described above), coordination to transition metals (including but not limited to Ti, Cr, Mn, Fe, Co, Ni, Cu, Zn, Zr, Nb, Mo, Ag, Au), ring opening or ring closing reactions (rotaxanes, spiro compounds, etc.).

Electrochemical modifiers can also be added to the polymer system through physical blending. Physical blending can include but is not limited to melt blending of polymers and/or co-polymers, the inclusion of discrete particles, chemical vapor deposition of the electrochemical modifier and co-precipitation of the electrochemical modifier and the main polymer material.

In some instances, the electrochemical modifier can be added via a metal salt solid, solution, or suspension. The metal salt solid, solution or suspension may comprise acids and/or alcohols to improve solubility of the metal salt. In yet another variation, the polymer gel (either before or after an optional drying step) is contacted with a paste comprising the electrochemical modifier. In yet another variation, the polymer gel (either before or after an optional drying step) is contacted with a metal or metal oxide sol comprising the desired electrochemical modifier.

In addition to the above exemplified electrochemical modifiers, the composite materials may comprise one or more additional forms (i.e., allotropes) of carbon. In this regard, it has been found that inclusion of different allotropes of carbon such as graphite, amorphous carbon, conductive carbon, carbon black, diamond, C60, carbon nanotubes (e.g., single and/or multi-walled), graphene and/or carbon fibers into the composite materials is effective to optimize the electrochemical properties of the composite materials. The various allotropes of carbon can be incorporated into the carbon materials during any stage of the preparation process described herein. For example, during the solution phase, during the gelation phase, during the curing phase, during the pyrolysis phase, during the milling phase, or after milling. In some embodiments, the second carbon form is incorporated into the composite material by adding the second carbon form before or during polymerization of the polymer gel as described in more detail herein. The polymerized polymer gel containing the second carbon form is then processed according to the general techniques described herein to obtain a carbon material containing a second allotrope of carbon.

In some embodiments, the polymer precursor is a polyvinilbenzene spheres produced by precipitation polymerization. In other embodiments, the polymer precursor in the low or essentially solvent free reaction mixture is a urea or an amine containing compound. For example, in some embodiments the polymer precursor is urea, melamine, hexamethylenetetramine (HMT) or combination thereof. Other embodiments include polymer precursors selected from isocyanates or other activated carbonyl compounds such as acid halides and the like.

Some embodiments of the disclosed methods include preparation of low or solvent-free polymer gels (and carbon materials) comprising electrochemical modifiers. Such electrochemical modifiers include, but are not limited to nitrogen, silicon, and sulfur. In other embodiments, the electrochemical modifier comprises fluorine, iron, tin, silicon, nickel, aluminum, zinc, or manganese. The electrochemical modifier can be included in the preparation procedure at any step. For example, in some the electrochemical modifier is admixed with the mixture, the polymer phase or the continuous phase.

The porous carbon material can be achieved via pyrolysis of a polymer produced from precursor materials as described above. In some embodiments, the porous carbon material comprises an amorphous activated carbon that is produced by pyrolysis, physical or chemical activation, or combination thereof in either a single process step or sequential process steps.

The temperature and dwell time of pyrolysis can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the pyrolysis temperature varies from 650° C. to 1100° C. The pyrolysis can be accomplished in an inert gas, for example nitrogen, or argon.

In some embodiments, an alternate gas is used to further accomplish carbon activation. In certain embodiments, pyrolysis and activation are combined. Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the temperature for combined pyrolysis and activation varies from 650° C. to 1100° C.

In some embodiments, combined pyrolysis and activation is carried out to prepare the porous carbon scaffold. In such embodiments, the process gas can remain the same during processing, or the composition of process gas may be varied during processing. In some embodiments, the addition of an activation gas such as CO2, steam, or combination thereof, is added to the process gas following sufficient temperature and time to allow for pyrolysis of the solid carbon precursors.

Suitable gases for accomplishing carbon activation include, but are not limited to, carbon dioxide, carbon monoxide, water (steam), air, oxygen, and further combinations thereof. The temperature and dwell time of activation can be varied, for example the dwell time can vary from 1 min to 10 min, from 10 min to 30 min, from 30 min to 1 hour, for 1 hour to 2 hours, from 2 hours to 4 hours, from 4 hours to 24 h. The temperature can be varied, for example, the pyrolysis temperature can vary from 200° C. to 300° C., from 250° C. to 350° C., from 350° C. to 450° C., from 450° C. to 550° C., from 540° C. to 650° C., from 650° C. to 750° C., from 750° C. to 850° C., from 850° C. to 950° C., from 950° C. to 1050° C., from 1050° C. to 1150° C., from 1150° C. to 1250° C. In some embodiments, the activation temperature varies from 650° C. to 1100° C.

Either prior to the pyrolysis, and/or after pyrolysis, and/or after activation, the carbon may be subjected to a particle size reduction. The particle size reduction can be accomplished by a variety of techniques known in the art, for example by jet milling in the presence of various gases including air, nitrogen, argon, helium, supercritical steam, and other gases known in the art. Other particle size reduction methods, such as grinding, ball milling, jet milling, water jet milling, and other approaches known in the art are also envisioned.

The porous carbon scaffold may be in the form of particles. The particle size and particle size distribution can be measured by a variety of techniques known in the art, and can be described based on fractional volume. In this regard, the Dv50 of the carbon scaffold may be between 10 nm and 10 mm, for example between 100 nm and 1 mm, for example between 1 um and 100 um, for example between 2 um and 50 um, example between 3 um and 30 um, example between 4 um and 20 um, example between 5 um and 10 um. In certain embodiments, the Dv50 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv100 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv99 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv90 is less than 1 mm, for example less than 100 um, for example less than 50 um, for example less than 30 um, for example less than 20 um, for example less than 10 um, for example less than 8 um, for example less than 5 um, for example less than 3 um, for example less than 1 um. In certain embodiments, the Dv0 is greater than 10 nm, for example greater than 100 nm, for example greater than 500 nm, for example greater than 1 um, for example greater than 2 um, for example greater than 5 um, for example greater than 10 um. In certain embodiments, the Dv1 is greater than 10 nm, for example greater than 100 nm, for example greater than 500 nm, for example greater than 1 um, for example greater than 2 um, for example greater than 5 um, for example greater than 10 um. In certain embodiments, the Dv10 is greater than 10 nm, for example greater than 100 nm, for example greater than 500 nm, for example greater than 1 um, for example greater than 2 um, for example greater than 5 um, for example greater than 10 um.

In some embodiments, the surface area of the porous carbon scaffold can comprise a surface area greater than 400 m²/g, for example greater than 500 m²/g, for example greater than 750 m²/g, for example greater than 1000 m²/g, for example greater than 1250 m²/g, for example greater than 1500 m²/g, for example greater than 1750 m²/g, for example greater than 2000 m²/g, for example greater than 2500 m²/g, for example greater than 3000 m²/g. In other embodiments, the surface area of the porous carbon scaffold can be less than 500 m²/g. In some embodiments, the surface area of the porous carbon scaffold is between 200 and 500 m²/g. In some embodiments, the surface area of the porous carbon scaffold is between 100 and 200 m²/g. In some embodiments, the surface area of the porous carbon scaffold is between 50 and 100 m²/g. In some embodiments, the surface area of the porous carbon scaffold is between 10 and 50 m²/g. In some embodiments, the surface area of the porous carbon scaffold can be less than 10 m²/g.

In some embodiments, the pore volume of the porous carbon scaffold is greater than 0.4 cm³/g, for example greater than 0.5 cm³/g, for example greater than 0.6 cm³/g, for example greater than 0.7 cm³/g, for example greater than 0.8 cm³/g, for example greater than 0.9 cm³/g, for example greater than 1.0 cm³/g, for example greater than 1.1 cm³/g, for example greater than 1.2 cm³/g, for example greater than 1.4 cm³/g, for example greater than 1.6 cm³/g, for example greater than 1.8 cm³/g, for example greater than 2.0 cm³/g. In other embodiments, the pore volume of the porous carbon scaffold is less than 0.5 cm³, for example between 0.1 cm³/g and 0.5 cm³/g. In certain other embodiments, the pore volume of the porous carbon scaffold is between 0.01 cm³/g and 0.1 cm³/g.

In some other embodiments, the porous carbon scaffold is an amorphous activated carbon with a pore volume between 0.2 and 2.0 cm³/g. In certain embodiments, the carbon is an amorphous activated carbon with a pore volume between 0.4 and 1.5 cm³/g. In certain embodiments, the carbon is an amorphous activated carbon with a pore volume between 0.5 and 1.2 cm³/g. In certain embodiments, the carbon is an amorphous activated carbon with a pore volume between 0.6 and 1.0 cm³/g.

In some other embodiments, the porous carbon scaffold comprises a tap density of less than 1.0 g/cm³, for example less than 0.8 g/cm³, for example less than 0.6 g/cm³, for example less than 0.5 g/cm³, for example less than 0.4 g/cm³, for example less than 0.3 g/cm³, for example less than 0.2 g/cm³, for example less than 0.1 g/cm³.

The surface functionality of the porous carbon scaffold can vary. One property which can be predictive of surface functionality is the pH of the porous carbon scaffold. The presently disclosed porous carbon scaffolds comprise pH values ranging from less than 1 to about 14, for example less than 5, from 5 to 8 or greater than 8. In some embodiments, the pH of the porous carbon is less than 4, less than 3, less than 2 or even less than 1. In other embodiments, the pH of the porous carbon is between about 5 and 6, between about 6 and 7, between about 7 and 8 or between 8 and 9 or between 9 and 10. In still other embodiments, the pH is high and the pH of the porous carbon ranges is greater than 8, greater than 9, greater than 10, greater than 11, greater than 12, or even greater than 13.

The pore volume distribution of the porous carbon scaffold can vary. For example, the % micropores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable micropore volume in the porous carbon scaffold.

The mesopores comprising the porous carbon scaffold can vary. For example, the % mesopores can comprise less than 30%, for example less than 20%, for example less than 10%, for example less than 5%, for example less than 4%, for example less than 3%, for example less than 2%, for example less than 1%, for example less than 0.5%, for example less than 0.2%, for example, less than 0.1%. In certain embodiments, there is no detectable mesopore volume in the porous carbon scaffold.

In some embodiments, the pore volume distribution of the porous carbon scaffold comprises more than 50% macropores, for example more than 60% macropores, for example more than 70% macropores, for example more than 80% macropores, for example more than 90% macropores, for example more than 95% macropores, for example more than 98% macropores, for example more than 99% macropores, for example more than 99.5% macropores, for example more than 99.9% macropores.

In certain preferred embodiments, the pore volume of the porous carbon scaffold comprises a blend of micropores, mesopores, and macropores. Accordingly, in certain embodiments, the porous carbon scaffold comprises 0-20% micropores, 30-70% mesopores, and less than 10% macropores. In certain other embodiments, the porous carbon scaffold comprises 0-20% micropores, 0-20% mesopores, and 70-95% macropores. In certain other embodiments, the porous carbon scaffold comprises 20-50% micropores, 50-80% mesopores, and 0-10% macropores. In certain other embodiments, the porous carbon scaffold comprises 40-60% micropores, 40-60% mesopores, and 0-10% macropores. In certain other embodiments, the porous carbon scaffold comprises 80-95% micropores, 0-10% mesopores, and 0-10% macropores. In certain other embodiments, the porous carbon scaffold comprises 0-10% micropores, 30-50% mesopores, and 50-70% macropores. In certain other embodiments, the porous carbon scaffold comprises 0-10% micropores, 70-80% mesopores, and 0-20% macropores. In certain other embodiments, the porous carbon scaffold comprises 0-20% micropores, 70-95% mesopores, and 0-10% macropores. In certain other embodiments, the porous carbon scaffold comprises 0-10% micropores, 70-95% mesopores, and 0-20% macropores.

In certain embodiments, the % of pore volume in the porous carbon scaffold representing pores between 100 and 1000 A (10 and 100 nm) comprises greater than 30% of the total pore volume, for example greater than 40% of the total pore volume, for example greater than 50% of the total pore volume, for example greater than 60% of the total pore volume, for example greater than 70% of the total pore volume, for example greater than 80% of the total pore volume, for example greater than 90% of the total pore volume, for example greater than 95% of the total pore volume, for example greater than 98% of the total pore volume, for example greater than 99% of the total pore volume, for example greater than 99.5% of the total pore volume, for example greater than 99.9% of the total pore volume.

In certain embodiments, the pycnometry density of the porous carbon scaffold ranges from about 1 g/cc to about 3 g/cc, for example from about 1.5 g/cc to about 2.3 g/cc. In other embodiments, the skeletal density ranges from about 1.5 cc/g to about 1.6 cc/g, from about 1.6 cc/g to about 1.7 cc/g, from about 1.7 cc/g to about 1.8 cc/g, from about 1.8 cc/g to about 1.9 cc/g, from about 1.9 cc/g to about 2.0 cc/g, from about 2.0 cc/g to about 2.1 cc/g, from about 2.1 cc/g to about 2.2 cc/g or from about 2.2 cc/g to about 2.3 cc/g, from about 2.3 cc to about 2.4 cc/g, for example from about 2.4 cc/g to about 2.5 cc/g.

In some embodiments, the carbon scaffold pore volume distribution can be described as the number or volume distribution of pores as determined as known in the art based on gas sorption analysis, for example nitrogen gas sorption analysis. In some embodiments the pore size distribution can be expressed in terms of the pore size at which a certain fraction of the total pore volume resides at or below. For example, the pore size at which 10% of the pores reside at or below can be expressed at DPv10.

The DPv10 for the porous carbon scaffold can vary, for example DPv10 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm.

The DPv50 for the porous carbon scaffold can vary, for example DPv50 can be between 0.01 nm and 100 nm, for example between 0.1 nm and 100 nm, for example between 1 nm and 100 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 and 100, for example between 2 and 50, for example between 2 and 30, for example between 2 and 20, for example between 2 and 15, for example between 2 and 10.

The DPv90 for the porous carbon scaffold can vary, for example DPv90 can be between 0.01 nm and 100 nm, for example between 0.1 nm and 100 nm, for example between 1 nm and 100 nm, for example between 1 nm and 50 nm, for example between 1 nm and 50 nm, for example between 1 nm and 40 nm, for example between 1 nm and 30 nm, for example between 1 nm and 10 nm, for example between 1 nm and 5 nm. In other embodiments, the DPv50 is between 2 nm and 100 nm, for example between 2 nm and 50 nm, for example between 2 nm and 30 nm, for example between 2 nm and 20 nm, for example between 2 nm and 15 nm, for example between 2 nm and 10 nm.

In some embodiments, the DPv90 is less than 100 nm, for example less than 50 nm, for example less than 40 nm, for example less than 30 nn, for example less than 20 nn, for example less than 15 nm, for example less than 10 nm. In some embodiments, the carbon scaffold comprises a pore volume with greater than 70% micropores (and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm. In other embodiments, the carbon scaffold comprises a pore volume with greater than 80% micropores and DPv90 less than 100 nm, for example DPv90 less than 50 nm, for example DPv90 less than 40 nm, for example DPv90 less than 30 nm, for example DPv90 less than 20 nm, for example DPv90 less than 15 nm, for example DPv90 less than 10 nm, for example DPv90 less than 5 nm, for example DPv90 less than 4 nm, for example DPv90 less than 3 nm.

The DPv99 for the porous carbon scaffold can vary, for example DPv99 can be between 0.01 nm and 1000 nm, for example between 0.1 nm and 1000 nm, for example between 1 nm and 500 nm, for example between 1 nm and 200 nm, for example between 1 nm and 150 nm, for example between 1 nm and 100 nm, for example between 1 nm and 50 nm, for example between 1 nm and 20 nm. In other embodiments, the DPv99 is between 2 nm and 500 nm, for example between 2 nm and 200 nm, for example between 2 nm and 150 nm, for example between 2 nm and 100 nm, for example between 2 nm and 50 nm, for example between 2 nm and 20 nm, for example between 2 nm and 15 nm, for example between 2 nm and 10 nm.

In certain embodiments, the carbon scaffold is modified prior to impregnation of lithium. For example, in certain embodiments, the surface of the carbon pores is functionalized for the purpose of creating a more lithiophilic surface, i.e., surface that interacts preferentially with lithium or lithium containing precursor materials, wherein said preferential interaction can manifest as preferential diffusion, deposition, adsorption of the like.

In some embodiments metal oxides are used to functionalize the porous carbon and improve lithiophilicity and thereby improve SEI stability of a lithium metal anode. In this embodiment, a porous carbon scaffold is modified with zinc oxide via a hydrothermal sol-gel synthesis reaction. Zinc acetate dihydrate is dissolved in water and stirred with micronized porous carbon powder. A strong oxidizing agent such as NaOH is then added dropwise into the reaction solution and allowed to react for up to 2 hours, before being separated by filtration and allowed to dry. In some embodiments the metal oxide may be aluminum oxide, nickel oxide, manganese oxide, cobalt oxide, tin oxide, or titanium oxide.

In still further embodiments the metal oxide is deposited via atomic layer deposition, physical vapor deposition onto the porous carbon surface and then subsequently converted to a metal oxide via chemical or thermal oxidation reactions. In still further embodiments, the porous carbon may be coated with a polymer containing lithium.

### C. Impregnation of Lithium in Carbon Via Chemical Vapor Infiltration (CVI)

Chemical vapor deposition (CVD) is a process wherein a substrate provides a solid surface comprising the first component of the composite, and the gas thermally decomposes on this solid surface to provide the second component of the composite. Such a CVD approach can be employed, for instance, to create Li—C composite materials wherein the lithium is coating on the outside surface of carbon particles. Alternatively, chemical vapor infiltration (CVI) is a process wherein a substrate provides a porous scaffold comprising the first component of the composite, and the gas thermally decomposes within the porosity (into the pores) of the porous scaffold material to provide the second component of composite.

In an embodiment, lithium is created within the pores of the porous carbon scaffold by subjecting the porous carbon particles to a lithium containing precursor at elevated temperature such that the lithium containing precursor exists in a gaseous state. In certain embodiments, the porous scaffold is a porous pyrolyzed carbon material, and the resulting lithium-pyrolyzed carbon composite created by CVI is subject to processing to activate the carbon material according to activation methods generally described herein. In other embodiments, the porous scaffold is a porous polymer material, and the resulting lithium-polymer composite created by CVI is subject to processing to accomplish polymer pyrolysis according to pyrolysis methods generally described herein. In related embodiments, the porous scaffold is a porous polymer material, and the resulting lithium-polymer composite created by CVI is subject to processing to accomplish polymer pyrolysis and activation according to pyrolysis and activation methods generally described herein.

The gasified lithium containing precursor can be mixed with other inert gases, for example, nitrogen, argon, and combinations thereof. The temperature and time of processing can be varied, for example the temperature can be between 200° C. and 1700° C., for example between 200° C. and 300° C., for example between 300° C. and 400° C., for example between 400° C. and 500° C., for example between 500° C. and 600° C., for example between 600° C. and 700° C., for example between 700° C. and 800° C., for example between 800° C. and 900° C., for example between 900° C. and 1000° C., for example between 1000° C. and 1100° C., for example between 1100° C. and 1200° C., for example between 1200° C. and 1400° C., for example between 1300° C. and 1400° C. for example between 1400° C. and 1700° C.

In one embodiment, lithium is heated to achieve gasification at or above its boiling point (1330° C.). In other embodiments, the lithium-containing precursor is heated at or above its boiling point to achieve gasification. Exemplary lithium containing precursors in this regard include, but are not limited to, lithium acetylsalicylate (boiling point=350° C.), lithium amide (boiling point=430° C.), lithium bromide (boiling point=1265° C.), lithium tetraborohydride (boiling point=380° C.), lithium chloride (boiling point=1383° C.), lithium hydride (boiling point=950° C.), and lithium hydroxide (boiling point=1626° C.).

The pressure for the CVI process can be varied. In some embodiments, the pressure is atmospheric pressure. In some embodiments, the pressure is below atmospheric pressure. In some embodiments, the pressure is above atmospheric pressure.

### D. Impregnation of Lithium in Carbon Via Intrusion

Melt intrusion is a process wherein a liquid infiltrates into the pores of a porous scaffold material. Such a melt intrusion approach can be employed, for instance, to create Li—C composite materials wherein the lithium resides within the porosity (into the pores) of the porous scaffold material to provide the second component of composite.

Accordingly, the porous scaffold which is subject to melt intrusion can be a porous polymer, porous pyrolyzed carbon, or porous activated carbon. The lithium-polymer composite created by melt intrusion can be subject to subsequent pyrolysis or subject to subsequent pyrolysis and activation. In other embodiments, the lithium-pyrolyzed carbon composite created by melt intrusion can be subject to subsequent activation.

The pressure for the melt intrusion process can be varied. In some embodiments, the pressure is atmospheric pressure. In some embodiments, the pressure is below atmospheric pressure. In some embodiments, the pressure is above atmospheric pressure.

The temperature to accomplish the melt intrusion can vary, for example the temperature can be between 25° C. and 1000° C., for example between 25° C. and 100° C., for example between 100° C. and 200° C., for example between 200° C. and 300° C., for example between 300° C. and 400° C., for example between 400° C. and 500° C., for example between 500° C. and 600° C., for example between 600° C. and 700° C., for example between 700° C. and 800° C., for example between 800° C. and 900° C., for example between 900° C. and 1000° C.

According to the melt intrusion process, the lithium can be in the form of elemental lithium, and the temperature of the process can be varied, for example at or above the melting point of lithium (180.5° C.). In other embodiments, lithium is comprised within a lithium containing precursor, which is heated at or above its melting point to facilitate the melt intrusion process. Exemplary lithium containing precursors in this regard include, but are not limited to, lithium carbonate (melting point=723° C.), lithium acetate (melting point=286° C.), lithium amide (melting point=374° C.), lithium bromide (melting point=550° C.), lithium tetraborohydride (melting point=268° C.), lithium chloride (melting point=610° C.), lithium fluoride (melting point=846° C.), lithium hydride (melting point=689° C.), and lithium hydroxide (melting point=471° C.), lithium hydrogen sulfate (melting point=171° C.), lithium dihydrogen phosphate (melting point=100° C.), lithium nitrate (melting point=261° C.), lithium phosphate (melting point=837° C.), lithium sulfate (melting point=860° C.), lithium sulfide (melting point=950° C.), lithium disulfide (melting point=370° C.), lithium sulfite (melting point=455° C.). Additional exemplary lithium containing precursors include lithium metal alloys including lithium aluminum alloy (melting point=718° C.), lithium aluminum copper alloys (melting point in range of 600° C. to 655° C.), lithium tin alloys (melting point in range of 344° C. to 488° C.), and lithium silicon alloys (melting point=700° C.).

In some embodiments, the non-lithium component of the lithium precursor remains within the lithium-carbon composite and can optionally serve as electrochemical modifier. In other embodiments, the non-lithium component of the lithium precursor is removed, for example by decomposition, extraction, or other methods known in the art. In some embodiments, any lithium that remains outside of the carbon pores or the porous carbon scaffold can be removed by a solvent wash, where exemplary solvents include, but are not limited to, naphthalene, toluene, or combinations thereof. In some embodiments, the lithium precursors introduced into the porous carbon by melt intrusion is converted to lithium by a chemical or electrochemical reduction process.

Exemplary agents for accomplishing reduction of the lithium containing precursor into lithium includes, but are not limited to, hydride reagents and dihydrogen, lithium aluminum hydride, boron hydrides such as sodium borohydride or diborane, metals and organometallic reagents such as the Grignard reagent, and dialkylcopper lithium (lithium dialkylcuprate) reagents such as sodium, alkyl sodium and alkyl lithium.

The melt intrusion process can be carried out in a batch process. Alternatively, the melt intrusion process can be carried out as a continuous process. In some embodiments, the melt intrusion process can be carried out as a continuous process employing extrusion.

In some embodiments the lithium-carbon composite is produced by a melt intrusion process comprising:
(i) physical mixing of porous carbon scaffold material and a lithium containing precursor material;
(ii) subjecting the mixture to temperature sufficient to achieve melting of the lithium containing precursor;
(iii) intrusion of the molten lithium containing precursor into the pores of the porous carbon scaffold.

In some embodiments the lithium-carbon composite is produced by a melt intrusion process comprising:
(i) physical mixing of porous carbon scaffold material and a lithium containing precursor material;
(ii) subjecting the mixture to temperature sufficient to achieve melting of the lithium containing precursor;
(iii) intrusion of the molten lithium containing precursor into the pores of the porous carbon scaffold;
(iv) conversion of the lithium containing precursor material into lithium.

According to this embodiment, the conversion of lithium containing precursor into lithium can be accomplished by various methods such as chemical or electrochemical reduction. In certain embodiments, the reduction is accomplished via reaction with a reducing gas environment, such as hydrogen gas.

In some embodiments the lithium-carbon composite is produced by a melt intrusion process comprising:
(i) physical mixing of porous carbon scaffold material and a lithium containing precursor material;
(ii) conversion of the lithium containing precursor material into lithium;
(iii) subjecting the mixture to temperature sufficient to achieve melting of the lithium;
(iv) intrusion of the lithium into the pores of the porous carbon scaffold.

According to this embodiment, the conversion of lithium containing precursor into lithium can be accomplished by various methods such as chemical or electrochemical reduction. In certain embodiments, the reduction is accomplished via reaction with a reducing gas environment, such as hydrogen gas.

In some embodiments the lithium-carbon composite is produced by a solute intrusion process comprising:
(i) physical mixing of porous carbon scaffold material and a lithium containing precursor material in the dry state;
(iii) subjecting the mixture to temperature sufficient to achieve melting of the lithium containing precursor;
(iv) further subjecting of the mixture to temperature and gas
in situ creation of lithium within the carbon pores
trusion of the molten lithium containing precursor into the pores of the porous carbon scaffold.

In some embodiments the lithium-carbon composite is produced by a solute intrusion process comprising:
(i) physical mixing of porous carbon scaffold material and a lithium containing precursor material dissolved in a solvent;
(ii) removal of the solvent;
(iii) subjecting the mixture to temperature sufficient to achieve melting of the lithium containing precursor;
(iv) intrusion of the molten lithium containing precursor into the pores of the porous carbon scaffold;
(v) conversion of the lithium containing precursor material into lithium.

According to this embodiment, the conversion of lithium containing precursor into lithium can be accomplished by various methods such as chemical or electrochemical reduction. In certain embodiments, the reduction is accomplished via reaction with a reducing gas environment, such as hydrogen gas.

In some embodiments the lithium-carbon composite is produced by a solute intrusion process comprising:
(i) physical mixing of porous carbon scaffold material and a lithium containing precursor material dissolved in a solvent;
(ii) removal of the solvent;
(iii) conversion of the lithium containing precursor material into lithium;
(iv) subjecting the mixture to temperature sufficient to achieve melting of the lithium precursor;
(v) intrusion of the molten lithium into the pores of the porous carbon scaffold.

According to this embodiment, the conversion of lithium containing precursor into lithium can be accomplished by various methods such as chemical or electrochemical reduction. In certain embodiments, the reduction is accomplished via reaction with a reducing gas environment, such as hydrogen gas.

### E. Impregnation of Lithium in Carbon by Co-Processing Lithium and Carbon Precursors

In some embodiments, carbon and lithium precursors are in situ co-processed to produce the lithium-carbon composite. Without being bound by theory, the lithium precursors are incorporated within the polymer resin that is formed as a transient intermediate between precursors and final lithium carbon composite. According to some embodiments, melting of the lithium containing precursor is no greater than the temperature employed to accomplish pyrolysis and/or activation to convert the carbon precursors into carbon. In one such embodiment, the lithium containing precursor can be lithium metal. In other embodiments, the lithium containing precursor can be lithium containing species disclosed elsewhere in this disclosure. In some embodiments, the melting and conversion of the lithium-containing precursor occur at a temperature no greater than the temperature employed to accomplish pyrolysis and/or activation to convert the carbon precursors into carbon. Accordingly, the conversion of lithium containing precursor into lithium can be accomplished by various methods such as chemical or electrochemical reduction. In certain embodiments, the reduction is accomplished via reaction with a reducing gas environment, such as hydrogen gas.

Exemplary lithium containing salts useful as precursors include, but are not limited to, dilithium tetrabromonickelate (II), dilithium tetrachlorocuprate (II), lithium azide, lithium benzoate, lithium bromide, lithium carbonate, lithium chloride, lithium cyclohexanebutyrate, lithium fluoride, lithium formate, lithium hexafluoroarsenate (V), lithium hexafluorophosphate, lithium hydroxide, lithium iodate, lithium iodide, lithium metaborate, lithium perchlorate, lithium phosphate, lithium sulfate, lithium tetraborate, lithium tetrachloroaluminate, lithium tetrafluoroborate, lithium thiocyanate, lithium trifluoromethanesulfonate, lithium trifluoromethanesulfonate, and combinations thereof.

### F. Impregnation of Lithium in Carbon by Electroplating

In one embodiment, the lithium carbon composite can be synthesized via an electroplating mechanism wherein an electrolytic cell is assembled with a porous carbon working electrode (prepared via slurry casting on a copper foil or nickel sheet current collector) and lithium metal counter electrode separated from each other in an liquid electrolyte containing a lithium salt (e.g., LiPF6, LiFSI, LiTFSI, LiCl, LiBr, LiI, LiNO3, etc.) and anhydrous organic solvent (e.g., propylene carbonate, ethylene carbonate, 1,3-dioxolane, 1,2-dimethoxyethane, tetrahydrofuran, acetonitrile, etc.). A negative voltage bias (e.g., −1V, −2V, −3V, −4V, −5V, −6V, etc.) is applied to facilitate Li+ reduction in the porous carbon electrode. The amount of charge (Ah) transferred is used to track Li metal loading and subsequently the applied voltage is stopped once a desired Li loading is achieved. The lithium-carbon electrode can then be transferred to and used as the anode in a Li-ion battery.

An embodiment similar to above wherein the porous carbon electrode is prepared on a roll-to-roll coater that is subsequently conveyed into an electrolyte bath (described above) housed in an inert atmosphere where a negative voltage bias is applied as described in the above embodiment and lithium plating takes place while the electrode is continuously in motion on the rollers. Therefore, the extent of the lithium metal loading is dictated by the conveyance speed of the roll-to-roll apparatus. Furthermore, the electrolyte bath may contain a dissolved polymer (e.g., polyacrylonitrile, polyvinylidene fluoride, polydopamine, etc.) such that when the electrode leaves the bath and subsequently dries the polymer film is left on the electrode surface acting as a barrier to the atmosphere thus minimizing oxidation of the lithium metal formed in the porous carbon.

In an alternative more preferred embodiment the lithium electroplating can be performed in-situ in an as-assembled Li-ion battery wherein the porous carbon electrode (described above) is the anode and a conventional Li-bearing transition metal oxide as known in the art (e.g., LiFePO₄, LiCoO₂, NCA, NMC111, NMC532, NMC622, etc.) acts as the cathode. Lithium electroplating takes place as the battery is charged to its 100% state of charge operating voltage (e.g., 4.2V). In this “anode-free” configuration the Lit source is the cathode. The process is reversed (Li+ stripping from the porous carbon electrode) when the battery is discharged. This embodiment is preferred because it does not require reactive lithium metal to be handled in an environment outside the battery and furthermore the energy density of the battery can be improved since the cathode acts as the sole source of Li+ in the system.

An embodiment similar to those above wherein the porous carbon electrode is instead replaced with a carbon nanotube (CNT) scaffold. The CNT's have the advantage of improved electronic conductivity and higher aspect ratios over porous carbon materials and thus could potentially lower the overpotential needed for Li+plating on its surface. Furthermore, the lack of internal porosity favors a surface centric Li plating/stripping mechanism thereby alleviating resistance due to narrow pore tortuosity. Lastly, the very low bulk densities of CNT relative to porous carbon allows for less of it (by mass) to be used across a given current collector surface area effectively increasing overall energy density of the resulting “anode-free” Li-ion battery.

In a related embodiment, the scaffold comprises a core particle of carbon decorated with carbon structure that are nanosized and/or nano-featured, wherein the decorated moiety serves to promote lithium plating. In such embodiments, the core carbon scaffold particle can be porous or non-porous, hard or graphite carbon; alternatively the core carbon scaffold particle can also comprise silicon or lithium impregnated into the core particle.

An embodiment wherein the lithium plating scaffold is a porous and electrically conductive but non-carbon material (e.g., copper, nickel, silicon, titanium, aluminum foil or foam). The substrate can be made more porous via acid etching (e.g., in HCl, HNO₃, and/or HF, etc.) or through laser patterning so as to increase lithium loading capability. The non-carbon scaffold material can also undergo an alloying reaction with lithium prior to subsequent plating thereby reducing formation of dendrites. The high intrinsic electrical conductivity of these scaffolds can also translate to improved rate capability in the battery.

The lithium plating kinetics in the above embodiments can be controlled either galvanostatically (constant current) or potentiostatically (constant voltage). Galvanostatic plating is most prudent in an “anode-free” configuration in an as-assembled Li-ion battery. The current densities of which can be controlled from 0.1-0.5, 0.5-1, 1-2, 2-3, 3-4, or 4-5 mA/cm². Sometimes it may be more preferable to instead control the voltage for lithium plating especially when resistances are high and/or when electrode distances are far apart. Some example voltages between the two electrodes may include −0.1 to −0.5, −0.5 to −1, −1 to −2, −2 to −3, −3 to −4, and −4 to −6V. Electrolytes used in these electroplating systems may include one or more lithium salts (e.g., LiPF₆, LiFSI, LiTFSI, LiCl, LiBr, LiI, LiNO₃, LiBOB, LiClO₄ etc.) and concentrations of 0.1-0.5, 0.5-1, 1-2, 2-3, and 3-4 molar. In a solvent consisting of one or more anhydrous organic solvents (e.g., propylene carbonate, ethylene carbonate, diethyl carbonate, fluoroethylene carbonate, vinylidene carbonate, 1,3-dioxolane, 1,2-dimethoxyethane, tetrahydrofuran, acetonitrile, etc.) or ionic liquids (e.g., 1-Butyl-3-methylimidazolium hexafluorophosphate, 1-methyl-1-propylpiperidinium bis(trifluoromethylsulfonyl)imide, N-ethyl-N-methylpyrrolidinium fluorohydrogenate, 1-ethyl-3-methyl-imidazolium bis(fluorosulfonyl)imide).

### G. Pre-Lithiation of Silicon-Carbon Composite Materials for Li-Ion Anodes

The method sand materials described in section C through F above wherein the porous carbon scaffold is instead a silicon-carbon composite for the purposes of pre-lithiation to compensate for electrochemical lithium losses with respect to solid electrolyte interphase (SEI) and/or trapping as a result of bulk structural rearrangement and expansion.

### H. Coatings Applied to Lithium-Carbon Composite

In certain embodiments, the lithium carbon composite particles comprise a terminal particle coating. Without being bound by theory, this coating can impart benefits such as enhanced electrochemical performance and increased safety for materials handling, battery construction and battery operation.

In certain embodiments, the surface layer can comprise a carbon layer. The surface layer is envisioned to provide for a suitable SEI layer. In this context, the surface carbon layer needs to be a good ionic conductor to shuttle Li-ions. Alternatively, the carbon layer can comprise an artificial SEI layer, for example the carbon layer can comprise poly(3,4-ethylenedioxythiophene)-co-poly(ethylene glycol) copolymer. The coating may comprise nitrogen and/or oxygen functionality to further improve the layer with respect to promoting a stable SEI layer. The coating needs to provide sufficient electrical conductivity, adhesion, and cohesion between particles. The surface should provide a stable SEI layer, the latter is typically comprised of species such as LiF, Li2CO3, and Li2O. Inorganic material with relatively low bulk modulus may provide a more stable SEI layer, for example a more amorphous vs. crystalline layer is preferred, for instance Li2CO3 vs. LiF.

To this end, a layer of carbon can be applied to the lithium carbon composite particle. Without being bound by theory, this carbon layer should provide low surface area to provide a more stable SEI layer, higher first cycle efficiency, and greater cycle stability in a lithium-ion battery. Various carbon allotropes can be envisioned in the context of providing a surface layer to the silicon-impregnated porous carbon materials, including graphite, graphene, hard or soft carbons, for example pyrolytic carbon.

In alternative embodiments, the aforementioned coating can be achieved with a precursor solution as known in the art, followed by a carbonization process. For example, particles can be coated by a wurster process or related spray drying process known in the art to apply a thin layer of precursor material on the particles. The precursor coating can then be pyrolyzed, for example by further fluidization of the wurster-coated particles in the presence of elevated temperature and an inert gas as consistent with descriptions disclosed elsewhere herein.

In alternative embodiments, the particles can be covered in a carbonaceous layer accomplished by chemical vapor deposition (CVD). Without wishing to be bound by theory, it is believed that CVD methods to deposit carbon layers (e.g., from a hydrocarbon gas) result in a carbon that is graphitizable (also referred to as “soft” carbon in the art). Methodologies for CVD generally described in the art can be applied to the composite materials disclosed herein. CVD is generally accomplished by subjecting the composite particulate material for a period of time at elevated temperature in the presence of a suitable deposition gas containing carbon atoms. Suitable gases in this context include, but are not limited to methane, propane, butane, cyclohexane, ethane, propylene, ethylene and acetylene. The temperature can be varied, for example between 350 to 1050° C., for example between 35° and 450° C., for example between 45° and 550° C., for example between 55° and 650° C., for example between 65° and 750° C., for example between 75° and 850° C., for example between 85° and 950° C., for example between 95° and 1050° C. In certain embodiments, the deposition gas is methane and the deposition temperature is greater than or equal to 950° C. In certain embodiments, the deposition gas is propane and the deposition temperature is less than or equal to 750° C. In certain embodiments, the deposition gas is cyclohexane and the deposition temperature is greater than or equal to 800° C. In certain embodiments, the deposition gas is acetylene and the deposition temperature is greater than or equal to 400 C. In certain embodiments, the deposition gas is ethylene and the deposition temperature is greater than or equal to 500 C. In certain embodiments, the deposition gas is propylene and the deposition temperature is greater than or equal to 400 C.

In certain embodiments, the reactor to accomplish the coating can be agitated, in order to agitate the lithium carbon composite particles. In other exemplary modes, the particles can be fluidized, for example the impregnation with silicon-containing reactant can be carried out in a fluidized bed reactor. A variety of different reactor designs can be employed in this context as known in the art, including, but not limited to, elevator kiln, roller hearth kiln, rotary kiln, box kiln, and modified fluidized bed designs.

The thickness of the carbon coating can vary, for example 1-2 nm, 2-5 nm, 5-10 nm, 10-20 nm, 20-50 nm, or 50-100 nm. The mass percentage of the carbon coating on the lithium carbon composite particles as a fraction of the total particle mass can vary, for example 0.01-0.1%, 0.1-0.5%, 0.5-1%, 1-2%, 2-5%, or greater than 5%. In alternative embodiments, the terminal carbon coating can be 0.1% to 5%.

The composite material comprising lithium and carbon can also comprise a terminal coating that does not comprise carbon. In some embodiments, such a non carbonaceous coating can be accomplished by atomic layer deposition (ALD) as known in the art. The thickness of the ALD coating can vary, for example 1-2 nm, 2-5 nm, 5-10 nm, 10-20 nm, 20-50 nm, or 50-100 nm. The mass percentage of the ceramic coating on the lithium carbon composite particles as a fraction of the total particle mass can vary, for example 0.01-0.1%, 0.1-0.5%, 0.5-1%, 1-2%, 2-5%, or greater than 5%. Exemplary non-carbonaceous coatings in this regard include, but are not limited to, oxides comprising aluminum, oxides comprising zirconium, and oxides comprising titanium. In alternative embodiments, the terminal carALD coating can be 0.1% to 5%.

The lithium carbon composite material can also be terminally carbon coated via a hydrothermal carbonization wherein the particles are processed by various modes according to the art. Hydrothermal carbonization can be accomplished in an aqueous environment at elevated temperature and pressure. Examples of temperature to accomplish the hydrothermal carbonization vary, for example between 150° C. and 300° C., for example, between 170° C. and 270° C., for example between 180° C. and 260° C., for example, between 20° and 250° C. Alternatively, the hydrothermal carbonization can be carried out at higher temperatures, for example, between 20° and 1000° C., for example, between 30° and 400° C., for example between 40° and 600° C., for example between 60° and 750° C., for example between 75° and 1000° C. In some embodiments, the hydrothermal carbonization can be carried out at a temperature and pressure to achieve graphitic structures. The range of pressures suitable for conducting the hydrothermal carbonization are known in the art, and the pressure can vary, for example, increase, over the course of the reaction. The pressure for hydrothermal carbonization can vary from 0.1 MPa to 200 MPA. In certain embodiments the pressure of hydrothermal carbonization is between 0.5 MPa and 5 MPa. In other embodiments, the pressure of hydrothermal carbonization is between 1 MPa and 10 MPa, or between 5 and 20 MPa. In yet other embodiments, the pressure of hydrothermal carbonization is between 10 MPa and 50 MPa. In yet other embodiments, the pressure of hydrothermal carbonization is between 50 MPa and 150 MPa. In yet other embodiments, the pressure of hydrothermal carbonization is between 100 MPa and 200 MPa. Feedstock suitable as a carbon source for hydrothermal carbonization are also known in the art. Such feedstocks for hydrothermal carbonization typically comprise carbon and oxygen, these include, but are not limited to, sugars, oils, biowastes, polymers, and polymer precursors described elsewhere within this disclosure. In further embodiments, the hydrocarbon gas may be methane, propane, ethane, butane, butylene, benzene, toluene, styrene, propylene, or acetylene.

I. Doping with Electrochemical Modifiers

In certain embodiments, the lithium carbon composite material can be doped with species that accomplish modification of electrochemical properties. Such electrochemical modifiers can provide enhanced electrochemical properties including, but not limited to, increased capacity, reduced resistance, increased storage stability, lithium metal dendrite suppression, and increased cycle stability.

In some embodiments, the electrochemical modifier serves to suppress lithium dendrite formation. Lithium dendrite growth as a result of continuous (and often high rate) lithium plating/stripping can lead to battery failure (sometimes catastrophic) as a result of shorting the electrodes together. Porous carbon particles and/or electrodes thereof decorated with nano-metal seeds (e.g., Sn, Ni, In, Ag, Zn, Al, etc.) can alloy and/or form eutectics with lithium prior to reaching plating voltages. This can act to suppress dendrite formation by mitigating high localized current regions and lowering the overpotential (and thus resistance) for lithium plating. In certain related embodiments, the electrochemical modifier is a metal oxide, for example an oxide of Sn, Ni, In, Ag, Zn, Al, etc, or combinations thereof. In certain related embodiments, the electrochemical modifier comprises a phosphate, for example transition metal phosphate, alkali metal phosphate, or rare weather metal phosphates.

In certain embodiments, the electrochemical modifier can be as a non-metal dopant, for example, oxygen, nitrogen, fluorine, chlorine, phosphorus, silicon, transition metal, and the like. Without bound by theory, the non-metal dopant serves as an electronegative site to attract and grow lithium.

### J. Physico- and Electrochemical Properties of Lithium-Carbon Composite

In certain embodiments, the lithium particles embedded within the composite comprise nano-sized features. The nano-sized features can have a characteristic length scale, for example less than 2 nm, 2 nm to 50 nm, or greater than 50 nm.

The dispensation of the lithium within the carbon composite can vary, for example the lithium can be impregnated into the pores of the porous carbon, where the fractional filling of the carbon internal void volume can vary. For example, the percent filling of the lithium within the total carbon pore volume can be 1 to 90%, for example, 1% to 10%, 10% to 20%, 20% to 30%, 30% to 40%, 40% to 50%, 50% to 60%, 60% to 70%, 70% to 80%, or 80% to 90%, Alternatively, the percent filling of the lithium within the total carbon pore volume can be 15 to 85%, for example, 20% to 80%, 30% to 70%, or 40% to 60%.

The lithium domains can be interspersed into the carbon skeletal structure, and/or the lithium domains can be completely surrounded by carbon. The geometry of the lithium domains within the carbon can vary, for example can be spherical, cylindrical, or tortuous structures. In some embodiments, the lithium exists as a layer coating the inside of pores within the porous carbon scaffold.

The size of the impregnated lithium can vary, for example less than 2 nm, 2 nm to 5 nm, 5 nm to 10 nm, 5 nm to 20 nm, 5 nm to 30 nm, 2 nm to 50 nm, 2 nm to 30 nm, 5 nm to 50 nm, 10 nm to 100 nm, 10 to 150 nm, 50 nm to 150 nm, 300 nm to 1000 nm, or 2 nm to 1000 nm.

Certain physicochemical and electrochemical properties of the lithium carbon composite can vary. Certain such properties are exemplified in Table 1.

TABLE 1
Embodiments for lithium carbon composite properties.

| | In some embodiments the lithium carbon composite comprises . . . |
|---|---|
| Surface Area | <100 m²/g, <50 m²/g, <30 m²/g, <20 m²/g, <10 m²/g, <5 m²/g, <4 m²/g, <3 m²/g, <2 m²/g, <1 m²/g; |
| First Cycle | >75%, >80%, >85%, >90%, >91%, >92%, >93%, >94%, >95%, >96%, >97%, >98%, >99%; |
| Efficiency | |
| Reversible | >1300 mAh/g, >1600 mAh/g, >1700 mAh/g, >1800 mAh/g, >1900 mAh/g, >2000 mAh/g, >2100 |
| Capacity | mAh/g, >2200 mAh/g, >2300 mAh/g, >2400 mAh/g, >2500 mAh/g, >2600 mAh/g, >2700 |
| | mAh/g, >2800 mAh/g, >2900 mAh/g, >3000 mAh/g; and/or |
| Lithium | 10%-90%, 15-85%, 20%-80%, 30%-70%, 40%-60%. |
| Content by | |
| weight | |

According to Table 1, the lithium carbon composite may comprise combinations of various properties. For example, the lithium carbon composite may comprise surface area less than 100 m²/g, a first cycle efficiency greater than 80%, and a reversible capacity of at least 1300 mAh/g; or may comprise surface area less than 100 m²/g, a first cycle efficiency greater than 80%, and a reversible capacity of at least 1600 mAh/g; or may comprise surface area less than 20 m²/g, a first cycle efficiency greater than 85%, and a reversible capacity of at least 1600 mAh/g; or may comprise, surface area less than 10 m²/g, a first cycle efficiency greater than 85%, and a reversible capacity of at least 1600 mAh/g; or may comprise surface area less than 10 m²/g, a first cycle efficiency greater than 90%, and a reversible capacity of at least 1600 mAh/g; or may comprise surface area less than 10 m²/g, a first cycle efficiency greater than 90%, and a reversible capacity of at least 1800 mAh/g.

The lithium carbon composite can comprise a combination of the aforementioned properties, in addition to also comprising a carbon scaffold comprising properties also described herein. Accordingly, Table 2 provides a description of certain embodiments for combination of properties for the lithium carbon composite.

TABLE 2
Embodiments for lithium carbon composite properties.

| | In some embodiments the lithium |
|---|---|
| | carbon composite comprises . . . |
| Surface Area | <100 m²/g, <50 m²/g, <30 m²/g, <20 m²/g, <10 m²/g, <5 m²/g, <4 m²/g, <3 m²/g, <2 m²/g, <1 m²/g; |
| First Cycle | >75%, >80%, >85%, >90%, >91%, >92%, >93%, >94%, >95%, >96%, >97%, >98%, >99%; |
| Efficiency | |
| Reversible | >1300 mAh/g, >1600 mAh/g, >1700 mAh/g, >1800 mAh/g, >1900 mAh/g, >2000 mAh/g, >2100 |
| Capacity | mAh/g, >2200 mAh/g, >2300 mAh/g, >2400 mAh/g, >2500 mAh/g, >2600 mAh/g, >2700 |
| | mAh/g, >2800 mAh/g, >2900 mAh/g, >3000 mAh/g; |
| Average | ≥0.9969, ≥0.9970, ≥0.9975, ≥0.9980, ≥0.9985, ≥0.9990, ≥0.9995, ≥0.9999 |
| Coulombic | |
| efficiency | |
| Lithium | 10%-90%, 15-85%, 20%-80%, 30%-70%, 40%-60%, 30%-60% |
| Content by | |
| weight | |
| Carbon | 0.1-1.5 cm³/g, 0.2-1.2 cm³/g, 0.3-1.1 cm³/g, 0.4-1.0 cm³/g, 0.4-1.0 cm³/g, 0.5-1.0 cm³/g, 0.6-1.0 |
| Scaffold pore | cm³/g, 0.5-0.9 cm³/g, 0.4-1.0 cm³/g, >0.1 cm³/g, >0.2 cm³/g, >0.4 cm³/g, >0.6 cm³/g, >0.8 cm³/g; |
| volume | |
| % silicon | 15%-25%, 25%-35%, 20%-40%, 25%-50%, 30%-70%, 30%-60%, 60%-80%, 80%-100%; |
| content | |
| Scaffold pore | <1 nm, 1-5 nm, 5-1000 nm, 10-500 nm, 10-200 nm, 10-100 nm, 33-150 nm, 20-100 nm |
| size range | |
| Scaffold | >20%/>30%/>30%, <10/>30/>30, <5/>30/>30, <5/>40/>40, <1/>40/>40, <10/>70/>20, <10/>20/>70, |
| Percentage of | >10/>10/>80, <10/>80/>10, <5/>70/>20, <5/>20/>70, <5/>5/>80, <5/>80/>10, >80%/<20%/<20%, |
| microporosity/ | >70/<30/<10, >70/<30/<5, >70/<20/<10, >70/<10/<10, >70/<10/<5, >70/<5/<5, >80/<20/<10, |
| mesoporosity/ | >80/<20/<5, >80/<20/<1, >80/<10/<10, >80/<10/<5, >80/<10/<1, >90/<10/<10, >90/<10/<5, |
| macroporosity | >90/<10/<1, >90/<5/<1, >95/<5/<5, >90/<5/<1 |
| expressed as | |
| percentage of | |
| scaffold total | |
| pore volume | |

As used in herein, the percentage “microporosity,” “mesoporosity” and “macroporosity” refers to the percent of micropores, mesopores and macropores, respectively, as a percent of total pore volume. For example, a carbon scaffold having 90% microporosity is a carbon scaffold where 90% of the total pore volume of the carbon scaffold is formed by micropores.

According to Table 2, the lithium carbon composite may comprise combinations of various properties. For example, the lithium carbon composite may comprise surface area less than 100 m2/g, a first cycle efficiency greater than 80%, a reversible capacity of at least 1600 mAh/g, a lithium content of 15%-85%, a carbon scaffold total pore volume of 0.2-1.2 cm3/g wherein the scaffold pore volume comprises >80% micropores, <20% mesopores, and <10% macropores. For example, the lithium carbon composite may comprise surface area less than 20 m2/g, a first cycle efficiency greater than 85%, and a reversible capacity of at least 1600 mAh/g, a lithium content of 15%-85%, a carbon scaffold total pore volume of 0.2-1.2 cm3/g wherein the scaffold pore volume comprises >80% micropores, <20% mesopores, and <10% macropores. For example, the lithium carbon composite may comprise surface area less than 10 m2/g, a first cycle efficiency greater than 85%, and a reversible capacity of at least 1600 mAh/g, a lithium content of 15%-85%, a carbon scaffold total pore volume of 0.2-1.2 cm3/g wherein the scaffold pore volume comprises >80% micropores, <20% mesopores, and <10% macropores. For example, the lithium carbon composite may comprise surface area less than 10 m2/g, a first cycle efficiency greater than 90%, and a reversible capacity of at least 1600 mAh/g, a lithium content of 15%-85%, a carbon scaffold total pore volume of 0.2-1.2 cm3/g wherein the scaffold pore volume comprises >80% micropores, <20% mesopores, and <10% macropores. For example, the lithium carbon composite may comprise area less than 10 m2/g, a first cycle efficiency greater than 90%, and a reversible capacity of at least 1800 mAh/g, a lithium content of 15%-85%, a carbon scaffold total pore volume of 0.2-1.2 cm3/g wherein the scaffold pore volume comprises >80% micropores, <20% mesopores, and <10% macropores.

Also, according to Table 2, the lithium carbon composite may comprise a carbon scaffold with >80% micropores, lithium content of 30-60%, and average Coulombic efficiency of >0.9969. For example, the lithium carbon composite may comprise a carbon scaffold with >80% micropores, lithium content of 30-60%, average Coulombic efficiency of ≥0.9970, and Z<10. For example, the lithium carbon composite may comprise a carbon scaffold with >80% micropores, lithium content of 30-60%, and average Coulombic efficiency of ≥0.9975. For example, the lithium carbon composite may comprise a carbon scaffold with >80% micropores, lithium content of 30-60%, and average Coulombic efficiency of ≥0.9980. For example, the lithium carbon composite may comprise a carbon scaffold with >80% micropores, lithium content of 30-60%, and average Coulombic efficiency of ≥0.9985. For example, the lithium carbon composite may comprise a carbon scaffold with >80% micropores, lithium content of 30-60%, and average Coulombic efficiency of ≥0.9990. For example, the lithium carbon composite may comprise a carbon scaffold with >80% micropores, lithium content of 30-60%, and average Coulombic efficiency of ≥0.9995. For example, the lithium carbon composite may comprise a carbon scaffold with >80% micropores, lithium content of 30-60%, and average Coulombic efficiency of ≥0.9970. For example, the lithium carbon composite may comprise a carbon scaffold with >80% micropores, lithium content of 30-60%, and average Coulombic efficiency of ≥0.9999.

Without being bound by theory, the filling of lithium within the pores of the porous carbon traps porosity within the porous carbon scaffold particle, resulting in inaccessible volume, for example volume that is inaccessible to nitrogen gas. Accordingly, the lithium carbon composite material may exhibit a pycnometry density of less than 2.1 g/cm³, for example less than 2.0 g/cm³, for example less than 1.9 g/cm³, for example less than 1.8 g/cm³, for example less than 1.7 g/cm³, for example less than 1.6 g/cm³, for example less than 1.4 g/cm³, for example less than 1.2 g/cm³, for example less than 1.0 g/cm³.

In some embodiments, the lithium carbon composite material may exhibit a pycnometry density between 1.7 g/cm³ and 2.1 g/cm³, for example between 1.7 g·cm³ and 1.8 g/cm³, between 1.8 g·cm³ and 1.9 g/cm³, for example between 1.9 g·cm³ and 2.0 g/cm³, for example between 2.0 g·cm³ and 2.1 g/cm³. In some embodiments, the lithium carbon composite material may exhibit a pycnometry density between 1.8 g/cm³ and 2.1 g/cm³. In some embodiments, the lithium carbon composite material may exhibit a pycnometry density between 1.8 g·cm³ and 2.0 g/cm³. In some embodiments, the lithium carbon composite material may exhibit a pycnometry density between 1.9 g/cm³ and 2.1 g/cm³.

The pore volume of the composite material exhibiting extremely durable intercalation of lithium can range between 0.01 cm³/g and 0.2 cm³/g. In certain embodiments, the pore volume of the composite material can range between 0.01 cm³/g and 0.15 cm³/g, for example between 0.01 cm³/g and 0.1 cm³/g, for example between 0.01 cm³/g and 0.05 cm³/g.

The particle size distribution of the composite material exhibiting extremely durable intercalation of lithium is important to both determine power performance as well as volumetric capacity. As the packing improves, the volumetric capacity may increase. In one embodiment the distributions are either Gaussian with a single peak in shape, bimodal, or polymodal (>2 distinct peaks, for example trimodal). The properties of particle size of the composite can be described by the Dv0 (smallest particle in the distribution), Dv50 (average particle size) and Dv100 (maximum size of the largest particle). The optimal combination of particle packing and performance will be some combination of the size ranges below. The particle size reduction in such embodiments can be carried out as known in the art, for example by jet milling in the presence of various gases including air, nitrogen, argon, helium, supercritical steam, and other gases known in the art.

In one embodiment the Dv0 of the composite material can range from 1 nm to 5 microns. In another embodiment the Dv0 of the composite ranges from 5 nm to 1 micron, for example 5-500 nm, for example 5-100 nm, for example 10-50 nm. In another embodiment the Dv0 of the composite ranges from 500 nm to 2 microns, or 750 nm to 1 um, or 1-2 um, microns to 2 microns. In other embodiments, the Dv0 of the composite ranges from 2-5 um, or >5 um.

In some embodiments the Dv50 of the composite material ranges from 5 nm to 20 um. In other embodiments the Dv50 of the composite ranges from 5 nm to 1 um, for example 5-500 nm, for example 5-100 nm, for example 10-50 nm. In another embodiment the Dv50 of the composite ranges from 500 nm to 2 um, 750 nm to 1 um, 1-2 um. In still other embodiments, the Dv50 of the composite ranges from 1 to 1000 um, for example from 1-100 um, for example from 1-10 um, for example 2-20 um, for example 3-15 um, for example 4-8 um. In certain embodiments, the Dv50 is >20 um, for example >50 um, for example >100 um.

The span (Dv50)/(Dv90−Dv10), wherein Dv10, Dv50 and Dv90 represent the particle size at 10%, 50%, and 90% of the volume distribution, can be varied from example from 100 to 10, from 10 to 5, from 5 to 2, from 2 to 1; in some embodiments the span can be less than 1. In certain embodiments, the composite comprising carbon and porous lithium material particle size distribution is unimodal. In certain embodiments, the composite comprising carbon and porous lithium material particle size distribution has a right hand skew. In certain embodiments, the composite comprising carbon and porous lithium material particle size distribution has a left hand skew. In certain embodiments, the composite comprising carbon and porous lithium material particle size distribution can be multimodal, for example, bimodal, or trimodal.

The surface functionality of the presently disclosed composite material exhibiting extremely durable intercalation of lithium may be altered to obtain the desired electrochemical properties. One property which can be predictive of surface functionality is the pH of the composite materials. The presently disclosed composite materials comprise pH values ranging from less than 1 to about 14, for example less than 5, from 5 to 8 or greater than 8. In some embodiments, the pH of the composite materials is less than 4, less than 3, less than 2 or even less than 1. In other embodiments, the pH of the composite materials is between about 5 and 6, between about 6 and 7, between about 7 and 8 or between 8 and 9 or between 9 and 10. In still other embodiments, the pH is high and the pH of the composite materials ranges is greater than 8, greater than 9, greater than 10, greater than 11, greater than 12, or even greater than 13.

The lithium carbon composite material may comprise varying amounts of carbon, oxygen, hydrogen, and nitrogen as measured by gas chromatography CHNO analysis. In one embodiment, the carbon content of the composite is greater than 98 wt. % or even greater than 99.9 wt % as measured by CHNO analysis. In another embodiment, the carbon content of the lithium-carbon composite ranges from about 10-90%, for example 20-80%, for example 30-70%, for example 40-60%.

In some embodiments, lithium carbon composite material comprises a nitrogen content ranging from 0-90%, for example 0.1-1%, for example 1-3%, for example 1-5%, for example 1-10%, for example 10-20%, for example 20-30%, for example 30-90%.

In some embodiments, the oxygen content ranges from 0-90%, for example 0.1-1%, for example 1-3%, for example 1-5%, for example 1-10%, for example 10-20%, for example 20-30%, for example 30-90%.

The morphology of the carbon scaffold particles can vary. For example, the carbon scaffold particles are spherical in shape.

The lithium carbon composite material may also incorporate an electrochemical modifier selected to optimize the electrochemical performance of the non-modified composite. The electrochemical modifier may be incorporated within the pore structure and/or on the surface of the porous carbon scaffold, within the embedded lithium, or within the final layer of carbon, or conductive polymer, coating, or incorporated in any number of other ways. For example, in some embodiments, the composite materials comprise a coating of the electrochemical modifier (e.g., lithium or Al₂O₃) on the surface of the carbon materials. In some embodiments, the composite materials comprise greater than about 100 ppm of an electrochemical modifier. In certain embodiments, the electrochemical modifier is selected from iron, tin, silicon, nickel, aluminum and manganese.

In certain embodiments the electrochemical modifier comprises an element with the ability to lithiate from 3 to 0 V versus lithium metal (e.g. silicon, tin, sulfur). In other embodiments, the electrochemical modifier comprises metal oxides with the ability to lithiate from 3 to 0 V versus lithium metal (e.g. iron oxide, molybdenum oxide, titanium oxide). In still other embodiments, the electrochemical modifier comprises elements which do not lithiate from 3 to 0 V versus lithium metal (e.g. aluminum, manganese, nickel, metal-phosphates). In yet other embodiments, the electrochemical modifier comprises a non-metal element (e.g. fluorine, nitrogen, hydrogen). In still other embodiments, the electrochemical modifier comprises any of the foregoing electrochemical modifiers or any combination thereof (e.g. tin-silicon, nickel-titanium oxide).

The electrochemical modifier may be provided in any number of forms. For example, in some embodiments the electrochemical modifier comprises a salt. In other embodiments, the electrochemical modifier comprises one or more elements in elemental form, for example elemental iron, tin, silicon, nickel or manganese. In other embodiments, the electrochemical modifier comprises one or more elements in oxidized form, for example iron oxides, tin oxides, silicon oxides, nickel oxides, aluminum oxides or manganese oxides.

In certain embodiments, an oxidized porous carbon is prepared by heating a porous carbon as free flowing powder of monolith to between 300 C and 1000 C, or more preferably 400-500 C, under ambident air gas flow in a horizontal tube furnace and allowed to dwell from 0-12 hour, or more preferably 0.25-1 hour. The air flow may contain a concentration of oxygen between 1-100 mol %. The material is subsequently cooled to room temperature and removed from the furnace. The resulting oxidized porous carbon material is attrition milled to less than 25-micron particle size distribution for preparation of electrodes. This porous carbon is rich in oxygen surface functionality which facilitates formation of lithium oxides in the initial stage of electrochemical plating of lithium metal in a lithium-ion battery, thereby increasing the lithiophiolicity and reduction of detrimental dendrite growth.

The electrochemical properties of the composite material can be modified, at least in part, by the amount of the electrochemical modifier in the material, wherein the electrochemical modifier is an alloying material such as silicon, tin, indium, aluminum, germanium, gallium. Accordingly, in some embodiments, the composite material comprises at least 0.10%, at least 0.25%, at least 0.50%, at least 1.0%, at least 5.0%, at least 10%, at least 25%, at least 50%, at least 75%, at least 90%, at least 95%, at least 99% or at least 99.5% of the electrochemical modifier.

The particle size of the composite material may expand upon full lithiation as compared to the non-lithiated composite state. For example, the expansion factor, defined as ratio of the average particle size of particles of composite material upon lithiation divided by the average particle size under non-lithiated conditions. As described in the art, this expansion factor can be relatively large for previously known, non-optimal silicon-containing materials, for example about 4× (corresponding to a 400% volume expansion upon lithiation). The current inventors have discovered composite materials comprising a lithium composite material that can exhibit a lower extent of expansion, for example, the expansion factor can vary from 3.5 to 4, from 3.0 to 3.5, from 2.5 to 3.0, from 2.0 to 2.5, from 1.5 to 2.0, from 1.0 to 1.5.

It is envisioned that composite materials in certain embodiments will comprise a fraction of trapped pore volume, namely, void volume non-accessible to nitrogen gas as probed by nitrogen gas sorption measurement. Without being bound by theory, this trapped pore volume is important in that it provides volume into which silicon can expand upon lithiation. The internal void volume can be determined by various methods, such from pycnometry density and/or press density.

In certain embodiments, the ratio of trapped void volume to the lithium volume comprising the composite particle is between 0.1:1 and 10:1. For example, the ratio of trapped void volume to the silicon volume comprising the composite particle is between 1:1 and 5:1, or 5:1 to 10:1. In embodiments, the ratio of ratio of trapped void volume to the lithium volume comprising the composite particle is between 2:1 and 5:1, or about 3:1.

In certain embodiments, the electrochemical performance of the composite disclosed herein is tested in a half-cell; alternatively, the performance of the composite is tested in a full cell, for example a full cell coin cell, a full cell pouch cell, a prismatic cell, or other battery configurations known in the art. The anode composition comprising the composite can further comprise various species, as known in the art. Additional formulation components include, but are not limited to, conductive additives, such as conductive carbons such as Super C45, Super P, Ketjenblack carbons, and the like, conductive polymers and the like, binders such as styrene-butadiene rubber sodium carboxymethylcellulose (SBR-Na-CMC), polyvinylidene difluoride (PVDF), polyimide (PI), polyacrylic acid (PAA) and the like, and combinations thereof. In certain embodiments, the binder can comprise a lithium ion as a counterion (e.g., lithium polyacrylic acid (LiPAA), lithium carboxymethylcellulose (Li-CMC), etc.).

Other species comprising the electrode are known in the art. The % of active material in the electrode by weight can vary, for example between 1 and 5%, for example between 5 and 15%, for example between 15 and 25%, for example between 25 and 35%, for example between 35 and 45%, for example between 45 and 55%, for example between 55 and 65%, for example between 65 and 75%, for example between 75 and 85%, for example between 85 and 95%. In some embodiments, the active material comprises between 80 and 95% of the electrode. In certain embodiments, the amount of conductive additive in the electrode can vary, for example between 1 and 5%, between 5 and 15%, for example between 15 and 25%, for example between 25 and 35%. In some embodiments, the amount of conductive additive in the electrode is between 5 and 25%. In certain embodiments, the amount of binder can vary, for example between 1 and 5%, between 5 and 15%, for example between 15 and 25%, for example between 25 and 35%. In certain embodiments, the amount of conductive additive in the electrode is between 5 and 25%.

The anode comprising the lithium carbon composite material can be paired with various cathode materials to result in a full cell lithium-ion battery. Examples of suitable cathode materials are known in the art. Examples of such cathode materials include, but are not limited to LiCoO₂ (LCO), LiNi_{0.8}Co_{0.15}Al_{0.05}O₂ (NCA), LiNi_{1/3}Co_{1/3}Mn_{1/3}O₂ (NMC), LiNi_{0.5}Mn_{1.5}O₄ (LNMO), LiMn₂O₄ and variants (LMO), LiFePO₄ (LFP), FeF₂, CuF₂, and S.

For the full cell lithium carbon battery comprising a lithium carbon composite, the pairing of cathode to anode can be varied. For example, the ratio of cathode-to-anode capacity can vary from 0.7 to 1.3. In certain embodiments, the ratio of cathode-to-anode capacity can vary from 0.7 to 1.0, for example from 0.8 to 1.0, for example from 0.85 to 1.0, for example from 0.9 to 1.0, for example from 0.95 to 1.0. In other embodiments, the ratio of cathode-to-anode capacity can vary from 1.0 to 1.3, for example from 1.0 to 1.2, for example from 1.0 to 1.15, for example from 1.0 to 1.1, for example from 1.0 to 1.05. In yet other embodiments, the ratio of cathode-to-anode capacity can vary from 0.8 to 1.2, for example from 0.9 to 1.1, for example from 0.95 to 1.05.

For the full cell lithium carbon battery comprising the lithium carbon composite, the voltage window for charging and discharging can be varied. In this regard, the voltage window can be varied as known in the art. For instance, the choice of cathode plays a role in the voltage window chosen, as known in the art. Examples of voltage windows vary, for example, in terms of potential versus Li/Li+, from 2.0 V to 5.0 V, for example from 2.5 V to 4.5V, for example from 2.5V to 4.2V. In such embodiments, the plating voltage of the lithium carbon composite anode (charging of the battery) occurs between 0 and −100 mV, for example between 0 and −50 mV, for example between 0 and −40 mV, for example between 0 and −30 m, for example between 0 and −20 mV, for example between 0 and −10 mV, for example between 0 and −5 mV, for example between 0 and −1 mV.

To assess the ability of the lithium carbon anode to suppress lithium dendrite formation upon constant current charge/discharge cycling, one can assess the performance of a half cell with lithium metal foil as the counter electrode and the lithium carbon composite as the active material comprised within the working electrode. Specifically, the electrochemical test of the half cell comprises constant current charge/discharge cycling, with the desired result to minimize or eliminate short circuiting due to lithium dendrite formation.

For the full cell lithium carbon battery comprising the lithium carbon composite, the strategy for conditioning the cell can be varied as known in the art. For example, the conditioning can be accomplished by one or more charge and discharge cycles at various rate(s), for example at rates slower than the desired cycling rate. As known in the art, the conditioning process may also include a step to unseal the lithium ion battery, evacuate any gases generated during the conditioning process, followed by resealing the lithium ion battery.

For the lithium carbon battery comprising the lithium carbon composite, the cycling rate can be varied as known in the art, for example, the rate can between C/20 and 20 C, for example between C10 to 10 C, for example between C/5 and 5 C. In certain embodiments, the cycling rate is C/10. In certain embodiments, the cycling rate is C/5. In certain embodiments, the cycling rate is C/2. In certain embodiments, the cycling rate is 1 C. In certain embodiments, the cycling rate is 1 C, with periodic reductions in the rate to a slower rate, for example cycling at 1 C with a C/10 rate employed every 20^{th} cycle. In certain embodiments, the cycling rate is 2 C. In certain embodiments, the cycling rate is 4 C. In certain embodiments, the cycling rate is 5 C. In certain embodiments, the cycling rate is 10 C. In certain embodiments, the cycling rate is 20 C.

The lithium carbon exhibits a first cycle efficiency (FCE), as measured in a half or full cell as described above. In preferred embodiments, the FCE is greater or equal to 70%, for example 80%, for example 85%, for example 90%, for example 95%, for example 96%, for example 98%, for example 99%.

In certain embodiments, the electrolyte can comprise various additives known to provide improved performance, such as fluoroethylene carbonate (FEC) or other related fluorinated carbonate compounds, or ester co-solvents such as methyl butyrate, vinylene carbonate, and other electrolyte additives known to improve electrochemical performance.

Coulombic efficiency can be averaged, for example averaged over cycles 2 or later to cycle 20 or later when tested in a half cell. In certain embodiments, the average efficiency of the composite with extremely durable intercalation of lithium is greater than 0.9, or 90%. In certain embodiments, the average efficiency is greater than 0.95, or 95%. In certain other embodiments, the average efficiency is 0.99 or greater, for example 0.991 or greater, for example 0.992 or greater, for example 0.993 or greater, for example 0.994 or greater, for example 0.995 or greater, for example 0.996 or greater, for example 0.997 or greater, for example 0.998 or greater, for example 0.999 or greater, for example 0.9991 or greater, for example 0.9992 or greater, for example 0.9993 or greater, for example 0.9994 or greater, for example 0.9995 or greater, for example 0.9996 or greater, for example 0.9997 or greater, for example 0.9998 or greater, for example 0.9999 or greater.

The lithium carbon composite materials disclosed herein have utility as the key battery active material for lithium carbon batteries. For example, an anode-free electrochemical cell in which a freestanding lithium carbon composite acts as both the current collector and lithium host, rather than a conventional copper current collector. For example, an electrochemical cell in which the lithium carbon composite acts as the lithium source rather than a conventional intercalation-type cathode. For example, in a Li-ion capacitor application in which the lithium carbon composite acts as the Li-bearing anode paired with an activated carbon cathode.

### EXAMPLES

Example 1. Properties of various carbon scaffold materials. The properties of various carbon scaffold materials are presented in Table 3. The exemplary carbon materials vary in properties such as total pore volume (for example varying from 0.5 to greater than 2 cm³/g, and also varying percentages of micro-, meso- and macropores.

TABLE 3
Properties of various carbon scaffold materials.

| Carbon | Surface | Pore | % | % | % |
|---|---|---|---|---|---|
| Scaffold | Area | Volume | Micro- | Meso- | Macro- |
| # | (m²/g) | (cm³/g) | pores | pores | pores |
| 1 | 1710 | 0.762 | 93.1 | 6.8 | 0.1 |
| 2 | 1744 | 0.72 | 97.2 | 2.7 | 0.1 |
| 3 | 1581 | 0.832 | 69.1 | 30.9 | 0.1 |
| 4 | 1710 | 0.817 | 80.1 | 19.9 | 0 |
| 5 | 1835 | 0.9 | 82.2 | 17.8 | 0 |
| 6 | 1475 | 1.06 | 52.4 | 47.6 | 0 |
| 7 | 453 | 0.5 | 3.9 | 91.1 | 5.1 |
| 8 | 787 | 2.284 | 0 | 59.1 | 40.9 |
| 9 | 1713 | 0.76 | 91 | 9 | 0 |

Example 2. Melt infusion method of synthesis for lithium carbon composite (LCC). In a typical but preferred embodiment a portion of micronized porous carbon powder is placed in a metal or ceramic crucible and physically mixed with a portion of lithium metal in the form of foil or powder. The Li:C weight ratio is adjusted so as to partially fill the available pore volume of the carbon allowing for some residual void (e.g., 0.1, 0.2, 0.3, 0.4, 0.5, 0.6, 0.7, 0.8, 0.9, or 1 w/w Li:C). The mixture is then heated under in an inert atmosphere (e.g., argon, nitrogen, helium, or vacuum) to at least the melting point of the lithium metal (e.g, 180° C., 190° C., 200° C., 220° C., 250° C., 300° C., 400° C., etc.). The mixture dwells at peak temperature for a period of time (e.g., 0.1 hr, 1 hr, 2 hr, 5 hr, 10 hr, 24 hr, etc.) to allow molten lithium to permeate the carbon pore structure via capillary forces. The LCC is formed at this time then subsequently cooled to ambient temperature and removed for processing.

In another embodiment the lithium metal and porous carbon powder are kept separated in the same heated reactor environment and the temperature is heated much hotter to increase the vapor pressure of the molten lithium (e.g., 900° C., 1000° C., 1100° C., 1200° C., 1300° C., 1350° C., etc.). This would facilitate vapor phase deposition of lithium metal within the pore structure of the carbon via capillary condensation. The Li:C ratio would therefore be controlled by the dwell time at peak temperature (e.g., 0.1 hr, 1 hr, 2 hr, 5 hr, 10 hr, 24 hr, etc.).

In yet another embodiment the lithium metal source is in the form of an electrode/target for a plasma physical vapor deposition apparatus and the porous carbon is acting as the counter electrode. The synthesis of the LCC is performed by applying a voltage bias between the electrodes under a partial pressure of argon gas. This facilitates evaporation of the lithium metal via ion bombardment resulting in lithium metal deposition taking place on the porous carbon. The rate of deposition can be controlled by the applied voltage bias and current. The Li:C ratio can be controlled by dwell time similar to the above embodiments.

Example 3. Melt infusion method of synthesis for lithium carbon composites (LCC). In a typical but preferred embodiment a portion of micronized porous carbon powder is placed in a metal or ceramic crucible and physically mixed with a portion of lithium metal in the form of foil or powder. The Li:C weight ratio is adjusted so as to partially fill the available pore volume of the carbon allowing for some residual void (e.g., 0.1, 0.2, 0.3, 0.4, 0.5, 0.6, 0.7, 0.8, 0.9, or 1 w/w Li:C). The mixture is then heated under in an inert atmosphere (e.g., argon, nitrogen, helium, or vacuum) to at least the melting point of the lithium metal (e.g, 180° C., 190° C., 200° C., 220° C., 250° C., 300° C., 400° C., etc.). The mixture dwells at peak temperature for a period of time (e.g., 0.1 hr, 1 hr, 2 hr, 5 hr, 10 hr, 24 hr, etc.) to allow molten lithium to permeate the carbon pore structure via capillary forces. The LCC is formed at this time then subsequently cooled to ambient temperature and removed for processing.

In another embodiment the lithium metal and porous carbon powder are kept separated in the same heated reactor environment and the temperature is heated much hotter to increase the vapor pressure of the molten lithium (e.g., 900° C., 1000° C., 1100° C., 1200° C., 1300° C., 1350° C., etc.). This would facilitate vapor phase deposition of lithium metal within the pore structure of the carbon via capillary condensation. The Li:C ratio would therefore be controlled by the dwell time at peak temperature (e.g., 0.1 hr, 1 hr, 2 hr, 5 hr, 10 hr, 24 hr, etc.).

In yet another embodiment the lithium metal source is in the form of an electrode/target for a plasma physical vapor deposition apparatus and the porous carbon is acting as the counter electrode. The synthesis of the LCC is performed by applying a voltage bias between the electrodes under a partial pressure of argon gas. This facilitates evaporation of the lithium metal via ion bombardment resulting in lithium metal deposition taking place on the porous carbon. The rate of deposition can be controlled by the applied voltage bias and current. The Li:C ratio can be controlled by dwell time similar to the above embodiments.

Example 4. Liquid phase methods of synthesis for lithium carbon composites. In a typical embodiment a solution of naphthalene in an anhydrous aprotic ethereal solvent (e.g., tetrahydrofuran, dimethoxyethane, diethyl ether etc.) is prepared in an inert gas environment (e.g., argon, nitrogen, helium, etc.). While stirring or sonicating a portion of lithium metal (1:1 molar ratio to naphthalene) is added to the solution in the form of foil, pellets, or powder. The lithium metal is allowed to completely dissolve to a transparent green solution. Porous carbon is then added to the solution in a desired Li:C ratio as indicated in Example 1. Subsequently the solvent and naphthalene are then removed from the mixture via either solvent exchange with a non-ethereal aprotic solvent (e.g., toluene, acetonitrile, etc.) followed by evaporation to yield the dry LCC material which can then be removed for processing.

In another perhaps preferred embodiment the same synthesis procedure as in Example 1 is conducted but the mixture is then heated to a temperature so as to facilitate evaporation of both the naphthalene and solvent species (e.g., >220° C.). Leaving behind only the LCC material and foregoes the use of additional solvents.

Example 5. Vapor phase methods of synthesis for lithium carbon composites. An embodiment wherein lithium is created within the pores of the porous carbon scaffold by subjecting the porous carbon particles to a lithium containing precursor gas via chemical vapor infiltration (CVI) at elevated temperature and the presence of a lithium-containing gas, preferably lithium bis(trimethylsilyl)amide, in order to decompose said gas into lithium. In some embodiments, the lithium containing gas may be composed of organic derivatives (such as methyl lithium, phenyl lithium, and the like) or mixtures thereof. The lithium containing precursor gas can be mixed with other inert gas(es), for example, nitrogen gas, or hydrogen gas, or argon gas, or helium gas, or combinations thereof. The temperature and time of processing can be varied, for example the temperature can be between 100° C. and 900° C., for example between 100° C. and 250° C., for example between 250° C. and 300° C., for example between 300° C. and 350° C., for example between 300° C. and 400° C., for example between 350° C. and 450° C., for example between 350° C. and 400° C., for example between 400° C. and 500° C., for example between 500° C. and 600° C., for example between 600° C. and 700° C., for example between 700° C. and 800° C., for example between 800° C. and 900° C., for example between 600° C. and 1100° C. The mixture of gas can comprise between 0.1 and 1% gaseous lithium precursor and remainder inert gas. Alternatively, the mixture of gas can comprise between 1% and 10% lithium precursor and remainder inert gas. Alternatively, the mixture of gas can comprise between 10% and 20% lithium precursor and remainder inert gas. Alternatively, the mixture of gas can comprise between 20% and 50% lithium precursor and remainder inert gas. Alternatively, the mixture of gas can comprise above 50% lithium precursor and the remaining inert gas. Alternatively, the gas can essentially be 100% lithium precursor gas. The pressure for the CVI process can be varied. In some embodiments, the pressure is atmospheric pressure. In some embodiments, the pressure is below atmospheric pressure. In some embodiments, the pressure is above atmospheric pressure.

Example 6. Addition of alloying species for synthesis of lithium carbon composites. As is known in the art, lithium metal can be alloyed with other elements in some cases forming lower melting point (<180° C.) eutectic mixtures. These eutectic mixtures can be exploited to more easily direct formation/precipitation of lithium metal within the porous carbon structure. In one such embodiment, the porous carbon scaffold is first loaded with an alloying agent (e.g., silver) in the form of a solution containing the alloy precursor (e.g., 0.1M silver nitrate in water). The solution is added to the dry porous carbon powder via a technique known in the art as incipient wetness at a low relative concentration (e.g., 0.1%, 1%, 2%, 5%, or 10% w/w Ag:C). The water solvent is subsequently removed via evaporation and the alloy precursor is decomposed/reduced to its metal neutral oxidation state (i.e., silver metal) throughout the pore structure of the carbon in the form of discrete nano-particles (e.g., 1-50 nm in diameter). This Ag/C composite can then be used as the host material for lithium metal formation as described in the above synthesis Examples. In the case of Example 1, the melt infusion step of lithium metal within the carbon pores would preferentially occur where there is a silver nanoparticle since the eutectic melting point of ˜0.1 w/w Li/Ag alloy occurs at a lower temperature than lithium metal itself (i.e., 143° C. versus 180° C. for pure lithium). As the eutectic Li/Ag alloy reaches a lithium saturation point it will precipitate solid lithium from the eutectic melt thus directing the bulk of lithium metal formation in the carbon pore structure where the silver nano-particles originally resided. In another embodiment as in the case of Example 3, the silver nano-particles within the carbon pore structure can act as a catalytic seed particle for deposition and subsequent alloying of lithium metal from the lithium precursor gas during CVI.

Example 7. Reduction of lithium salts for synthesis of lithium carbon composites. An embodiment wherein lithium is created within the pores of the porous carbon scaffold by mixing the porous carbon particles with lithium salt (e.g., LiF, LiCl, LiNO3, Li2CO3, LiI, LiBr, LiAlH4, LiOH, Li2O, LiO2, Li3N, etc.) at elevated temperature with or without the presence of a reducing agent (e.g., H2, NaBH4, oxalic acid, glucose, carbon, etc.) in order to decompose said salt into lithium metal. The lithium salt can be pre-dissolved in solvents (e.g., tetrahydrofuran, propylene carbonate, acetone, etc.) so as to more easily flow/absorb into the nano-pores of the porous carbon scaffold. The reduction temperature and time of processing can be varied, for example the temperature can be between 0° C. and 900° C., for example between 0° C. and 250° C., for example between 250° C. and 300° C., for example between 300° C. and 350° C., for example between 300° C. and 400° C., for example between 350° C. and 450° C., for example between 350° C. and 400° C., for example between 400° C. and 500° C., for example between 500° C. and 600° C., for example between 600° C. and 700° C., for example between 700° C. and 800° C., for example between 800° C. and 900° C., for example between 600° C. and 1100° C. The solvent/salt mixture can comprise between 0.1 and 1% lithium salt and remainder liquid solvent. Alternatively, the mixture of solvent/salt can comprise between 1% and 10% lithium salt and remaining liquid solvent. Alternatively, the mixture of solvent/salt can comprise between 10% and 20% lithium salt and remaining liquid solvent. Alternatively, the mixture of solvent/salt can comprise between 20% and 50% lithium salt and remainder liquid solvent. Alternatively, the mixture of solvent/salt can comprise above 50% lithium salt and remaining liquid solvent. Alternatively, the solvent/salt can essentially be 100% lithium salt. The pressure for the reduction process can be varied. In some embodiments, the pressure is atmospheric pressure. In some embodiments, the pressure is below atmospheric pressure. In some embodiments, the pressure is above atmospheric pressure.

Example 8. Electrochemical methods of forming lithium carbon composites. In one embodiment, the lithium carbon composite can be synthesized via an electroplating mechanism wherein an electrolytic cell is assembled with a porous carbon working electrode (prepared via slurry casting on a copper foil or nickel sheet current collector) and lithium metal counter electrode separated from each other in an liquid electrolyte containing a lithium salt (e.g., LiPF6, LiFSI, LiTFSI, LiCl, LiBr, LiI, LiNO3, etc.) and anhydrous organic solvent (e.g., propylene carbonate, ethylene carbonate, 1,3-dioxolane, 1,2-dimethoxyethane, tetrahydrofuran, acetonitrile, etc.). A negative voltage bias (e.g., −1V, −2V, −3V, −4V, −5V, −6V, etc.) is applied to facilitate Li+reduction in the porous carbon electrode. The amount of charge (Ah) transferred is used to track Li metal loading and subsequently the applied voltage is stopped once a desired Li loading is achieved. The lithium-carbon electrode can then be transferred to and used as the anode in a Li-ion battery.

An embodiment similar to above wherein the porous carbon electrode is prepared on a roll-to-roll coater that is subsequently conveyed into an electrolyte bath (described above) housed in an inert atmosphere where a negative voltage bias is applied as described in the above embodiment and lithium plating takes place while the electrode is continuously in motion on the rollers. Therefore, the extent of the lithium metal loading is dictated by the conveyance speed of the roll-to-roll apparatus. Furthermore, the electrolyte bath may contain a dissolved polymer (e.g., polyacrylonitrile, polyvinylidene fluoride, polydopamine, etc.) such that when the electrode leaves the bath and subsequently dries the polymer film is left on the electrode surface acting as a barrier to the atmosphere thus minimizing oxidation of the lithium metal formed in the porous carbon.

In an alternative more preferred embodiment the lithium electroplating can be performed in-situ in an as-assembled Li-ion battery wherein the porous carbon electrode (described above) is the anode and a conventional Li-bearing transition metal oxide as known in the art (e.g., LiFePO₄, LiCoO₂, NCA, NMC111, NMC532, NMC622, etc.) acts as the cathode. Lithium electroplating takes place as the battery is charged to its 100% state of charge operating voltage (e.g., 4.2V). In this “anode-free” configuration the Lit source is the cathode. The process is reversed (Li+stripping from the porous carbon electrode) when the battery is discharged. This embodiment is preferred because it does not require reactive lithium metal to be handled in an environment outside the battery and furthermore the energy density of the battery can be improved since the cathode acts as the sole source of Li+ in the system.

Example 9. Terminal coating methods for lithium carbon composites. Owing to the highly reactive nature of lithium metal in atmospheric conditions (e.g., oxidative reaction with water, oxygen, and carbon dioxide) it may be necessary to coat/protect the surface of the lithium utilizing terminal coating methods described herein. In one embodiment following synthesis of the LCC as described in Examples 1-6 the composite is subsequently heated to temperature (e.g., 400-1000° C.) so as to facilitate decomposition of a hydrocarbon gas (e.g., acetylene, propylene, ethylene, methane, propane, propadiene/propyne, etc.). At peak temperature the hydrocarbon gas is introduced into the heated chamber containing the LCC material and allowed to undergo a chemical vapor deposition reaction depositing carbon on the surface of the LCC material according to the reaction equation CxHy->C+H2. The thickness of the coating can be controlled by the dwell time in which the hydrocarbon gas is present (e.g., 0.1 hr-6 hr). The application of the carbon coating will subsequently protect the silicon from oxidation in atmospheric conditions. In another embodiment the LCC material can be coated with a polymer (e.g., polydopamine, polyacrylonitrile, polyaniline, polypyrrole, etc.) to allow for lower temperature (e.g., <200° C.) processing.

Example 10. Surface functionality methods and metrics. The surface functionality of the presently disclosed composite material comprised of carbon and lithium may be altered to obtain the desired electrochemical properties. One such property for particulate composite materials is the concentration of atomic species at the surface of the composite material relative to the interior of the composite material. Such a difference in concentration of atomic species of the surface vs. interior of the particulate composite material can be determined as known in the art, for example by x-ray photoelectron spectroscopy (XPS). For example, the concentration of Li:C at the surface (defined as the terminal 5 nm of the particulate surface) may be determined by this method. In some embodiments the ratio of Li:C at the surface ranges from about 0.1:1 to 10:1. In certain other embodiments, the ratio of Li:C at the surface is about 0:1. In other embodiments, the ratio of Li:C at the surface is about 1:0. In another example, the Li:O ratio at the surface ranges from about 0:1 to 1:0.

Another property which can be predictive of surface functionality is the pH of the LCC composite materials. The presently disclosed composite materials comprise pH values ranging from less than 1 to about 14, for example less than 5, from 5 to 8 or greater than 8. In some embodiments, the pH of the composite materials is less than 4, less than 3, less than 2 or even less than 1. In other embodiments, the pH of the composite materials is between about 5 and 6, between about 6 and 7, between about 7 and 8 or between 8 and 9 or between 9 and 10. In still other embodiments, the pH is high and the pH of the composite materials ranges is greater than 8, greater than 9, greater than 10, greater than 11, greater than 12, or even greater than 13.

Other methods and metrics for determination of carbon structure include X-ray diffraction (XRD) and Raman spectroscopic analysis. With regards to XRD, the graphitic nature of carbon materials can be assessed by monitoring peak intensity at various 2q corresponding to various Miller indices. Without being bound by theory, diffraction lines of graphite are classified into various groups, such as 001, hk0, and hk1 indices, mainly because of the strong anisotropy in structure. One such species is 002, corresponding to basal planes of graphite, which is located at 2θ˜26°; this peak is prominent in highly graphitic carbon materials. Carbon material with lesser extent of graphite nature and small crystallite sizes may be characterized by very broad 001 lines (e.g., 002) and shifting (e.g. 2θ˜23°), due to the lesser extent of stacked layers, and by unsymmetrical hk lines (e.g., 10 corresponding to 2θ˜43°). Furthermore, the Scherrer formula may be used to calculate crystallite size (Lc) from the 002 line and crystallite size (La) from the 100 line.

With regards to Raman spectroscopy, this method can also be employed to assess graphite nature of carbon as reported in the art The position, shape, and magnitude of the Raman D- and G bands is known to the art for calculation of the La value from the Tuinstra Koenig (TK) model for >2 nm grain size or the Ferrari (FR) model (Ferrari, A. C., & Robertson, J. (1970); Tuinstra, F., & Koening, J. L. (1970). Raman spectrum of graphite. The Journal of Chemical Physics, 53 (3), 1126-1130). Interpretation of Raman spectra of disordered and amorphous carbon. Physical Review B, 61 (20), 14095-14107) when TK model calculates <2 nm grain size. These models provide a measure of the disorder in carbon materials and represent the length of the graphene crystallite sheets in carbon materials.

Yet another analysis method is determination of oxygen, nitrogen and hydrogen employing an inert gas fusion instrument. The lithium-carbon composite material may comprise varying amounts of carbon, oxygen, hydrogen and nitrogen as measured by an inert gas fusion instrument known in the art (LECO ONH 836). The lithium-carbon composite sample is flash heated in a graphite arc furnace to ˜3000° C. under flowing helium gas. The oxygen in the sample is carbo-thermally reduced to CO2 and/or CO which is entrained in the helium gas stream and quantified downstream using an IR spectrometer. Hydrogen is evolved from the sample in the form of H2 which is converted catalytically to H2O in the gas phase and quantified also using an IR spectrometer. Lastly, the nitrogen is evolved from the sample in the form of N2 and quantified using a thermal conductivity detector.

In some embodiments, lithium-carbon composite material comprises a nitrogen content ranging from 0-90%, for example 0.1-1%, for example 1-3%, for example 1-5%, for example 1-10%, for example 10-20%, for example 20-30%, for example 30-90%. In some embodiments, the oxygen content ranges from 0-90%, for example 0.1-1%, for example 1-3%, for example 1-5%, for example 1-10%, for example 10-20%, for example 20-30%, for example 30-90%.

Example 11. Stability of lithium carbon composite under ambient conditions. The instability of lithium metal under ambient conditions is well known in the art. The current disclosure provides for a lithium that is protected within a porous carbon scaffold, with optional terminal coating applied to the composite particle. This protection can be described in terms of the confinement of lithium within the carbon scaffold and is manifested as decreased or eliminated reactivity in air (oxygen), stability in contact with other battery components (chemical), stability in operation (electrochemical), and suppression of dendrites upon battery cycling. For example, a metric such as onset time or severity for reaction with organic solvent can be measured by H2 evolution and/or total quantity. Alternatively, one can measure onset time or severity of tarnishing/color change/oxidation of lithium-carbon in air. Alternatively, stability can be assessed by TGA/DSC by measuring mass uptake due to oxidation of the lithium within the composite. In addition, DSC also is known to provide information about lithium melting point, whose alteration yields information about the stability and/or disposition of lithium within the carbon scaffold porosity. Alternatively, stability can be measured in a half cell vs. lithium metal to determine the number of galvanostatic cycles until dendrite failure, i.e., short circuit of the half cell. Alternatively, stability can be assessed by small angle X-ray scattering (SAXS) or neutron scattering to determine the distribution and size of lithium in the pore of the porous carbon.

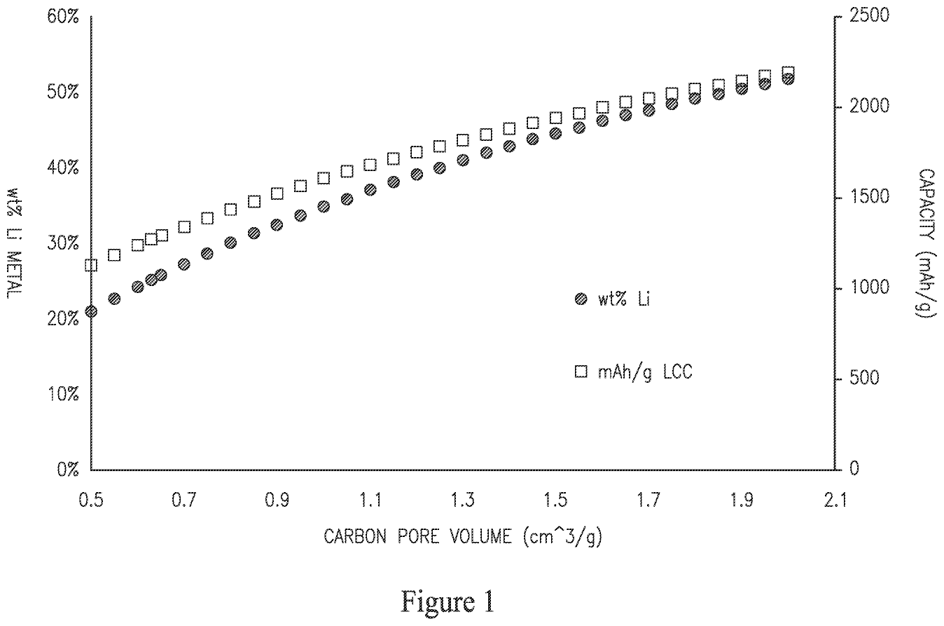

Example 12. Loading and capacity of lithium carbon composite. Without being bound by theory, the limit for impregnating lithium into the pores of the porous carbon is related to the carbon total pore volume. FIG. 1 depicts the lithium content, in terms of lithium percentage of the total composite mass basis (closed symbols, axis to the left of the plot). FIG. 1 also depicts the corresponding capacity in terms of mAh/g of composite (open symbols, axis to the right of the plot).

### EXPRESSED EMBODIMENTS

Embodiment 1. A lithium carbon composite comprising a plurality of primary particles comprising lithium and porous carbon, wherein the lithium particles are in a neutral metallic state residing within the nano-pore structure of the porous carbon and the porous carbon is in an amorphous state, and wherein the lithium content by mass constitutes 1-99% of the composite.

Embodiment 2. The composite of Embodiment 1 wherein the porous carbon comprises a pore volume that comprises micropores (diameter <20 angstroms) and mesopores (diameter 20-500 angstroms).

Embodiment 3. The composite of embodiment 2, wherein the porous carbon comprises a pore volume greater than 0.5 cm³/g.

Embodiment 4. The composite of embodiment 2, wherein the porous carbon comprises a pore volume greater than 0.6 cm³/g.

Embodiment 5. The composite of embodiment 2, wherein the porous carbon comprises a pore volume greater than 0.8 cm³/g.

Embodiment 6. The composite of embodiment 2, wherein the pore volume is greater than 1.0 cm³/g.

Embodiment 7. The composite of any embodiment from Embodiment 1 to Embodiment 6 wherein the lithium occupies between 1%-99% of the total pore volume of the porous carbon scaffold.

Embodiment 8. The composite of Embodiment 7 wherein the lithium occupies between 10%-90% of the total pore volume of the porous carbon scaffold.

Embodiment 9. The composite of Embodiment 7 wherein the lithium occupies between 20%-80% of the total pore volume of the porous carbon scaffold.

Embodiment 10. The composite of Embodiment 7 wherein the lithium occupies between 30%-70% of the total pore volume of the porous carbon scaffold.

Embodiment 11. The composite of Embodiment 7 wherein the lithium occupies between 50%-99% of the total pore volume of the porous carbon scaffold.

Embodiment 12. The composite of any embodiment from Embodiment 1 to Embodiment 11 wherein a population of the lithium present in the composite is in a +1 oxidation state occupying interstitial sites complexed with the carbon and forming different stoichiometries thereof (e.g., LixC6 where x=1-2).

Embodiment 13. The composite of any embodiment from Embodiment 1 to Embodiment 12 wherein other non-metal heteroatoms are chemically bound to the lithium and/or porous carbon. For example, oxygen with a mass fraction of 0.1-99% of the composite, for example hydrogen with a mass fraction of 0.1-99% of the composite, for example nitrogen with a mass fraction of 0.1-99% of the composite, for example fluorine with a mass fraction of 0.1-99% of the composite, for example silicon with a mass fraction of 0.1-99% of the composite, for example phosphorus with a mass fraction of 0.1-99% of the composite, for example boron with a mass fraction of 0.1-99% of the composite and combinations thereof.

Embodiment 14. The composite of any embodiment from Embodiment 1 to Embodiment 12 wherein other non-metal heteroatoms are chemically bound to the lithium and/or porous carbon. For example, oxygen with a mass fraction of 0.2-20% of the composite, for example hydrogen with a mass fraction of 0.2-20% of the composite, for example nitrogen with a mass fraction of 0.1-99% of the composite, for example fluorine with a mass fraction of 0.2-20% of the composite, for example silicon with a mass fraction of 0.1-99% of the composite, for example phosphorus with a mass fraction of 0.2-20% of the composite, for example boron with a mass fraction of 0.2-20% of the composite and combinations thereof.

Embodiment 15. The composite of any embodiment from Embodiment 1 to Embodiment 14 wherein the porous carbon component contains other non-lithium metals within its pore structure. For example tin with a mass fraction of 0.1-99% of the composite, for example aluminum with a mass fraction of 0.1-99% of the composite, for example indium with a mass fraction of 0.1-99% of the composite, for example silver with a mass fraction of 0.1-99% of the composite, for example nickel with a mass fraction of 0.1-99% of the composite, for example copper with a mass fraction of 0.1-99% of the composite, for example gold with a mass fraction of 0.1-99% of the composite, for example zinc with a mass fraction of 0.1-99% of the composite and combinations thereof.

Embodiment 16. The composite of any embodiment from Embodiment 1 to Embodiment 14 wherein the porous carbon component contains other non-lithium metals within its pore structure. For example tin with a mass fraction of 0.2-20% of the composite, for example aluminum with a mass fraction of 0.2-20% of the composite, for example indium with a mass fraction of 0.2-20% of the composite, for example silver with a mass fraction of 0.2-20% of the composite, for example nickel with a mass fraction of 0.2-20% of the composite, for example copper with a mass fraction of 0.2-20% of the composite, for example gold with a mass fraction of 0.2-20% of the composite, for example zinc with a mass fraction of 0.2-20% of the composite and combinations thereof.

Embodiment 17. The composite of any embodiment from Embodiment 1 to Embodiment 16 wherein the composite Dv50 is between 0.1 to 50 microns.

Embodiment 18. The composite of any embodiment from Embodiment 1 to Embodiment 17 wherein the composite particle shape is spheroidal.

Embodiment 19. The composite of any embodiment from Embodiment 1 to Embodiment 18 wherein the composite particle is coated on the surface with an amorphous carbon layer, for example via chemical vapor deposition of a hydrocarbon (e.g., acetylene, propylene, methane, propane, ethylene, and combinations thereof).

Embodiment 20. The composite of any embodiment from Embodiment 1 to Embodiment 19 wherein the composite particle is coated on the surface with an organic polymer layer, for example polydopamine, polyacrylonitrile, polyethylene glycol, polyvinylidene fluoride, polyaniline, polyacrylic acid, polysulfides and combinations thereof.

Embodiment 21. The composite of any embodiment from Embodiment 1 to Embodiment 20 wherein the composite particle is coated on the surface with a metal oxide, for example, Al₂O₃, TiO₂, ZrO₂, Li₂O, ZnO, SiO₂, and combinations thereof, using vapor-phase atomic layer deposition (ALD).

Embodiment 22. The composite of any embodiment from Embodiment 1 to Embodiment 20 wherein the composite particle is coated on the surface with a metal oxide, for example Al₂O₃, TiO₂, ZrO₂, Li₂O, ZnO, SiO₂, and combinations thereof, using a liquid-phase sol-gel process.

Embodiment 23. The composite of any embodiment from Embodiment 1 to Embodiment 22 wherein the composite comprises a capacity of greater than 900 mAh/g.

Embodiment 24. The composite of any embodiment from Embodiment 1 to Embodiment 22 wherein the composite comprises a capacity of greater than 1300 mAh/g.

Embodiment 25. The composite of any embodiment from Embodiment 1 to Embodiment 22 wherein the composite comprises a capacity of greater than 1600 mAh/g.

Embodiment 26. The composite of any embodiment from Embodiment 1 to Embodiment 25, wherein the composite comprises an average Coulombic efficiency of >0.9970.

Embodiment 27. The composite of any embodiment from Embodiment 1 to Embodiment 25, wherein the composite comprises an average Coulombic efficiency of >0.9980.

Embodiment 28. The composite of any embodiment from Embodiment 1 to Embodiment 25, wherein the composite comprises an average Coulombic efficiency of >0.9985.

Embodiment 29. The composite of any embodiment from Embodiment 1 to Embodiment 25, wherein the composite comprises an average Coulombic efficiency of >0.9990.

Embodiment 30. The composite of any embodiment from Embodiment 1 to Embodiment 25, wherein the composite comprises an average Coulombic efficiency of >0.9995.

Embodiment 31. The composite of any embodiment from Embodiment 1 to Embodiment 25, wherein the composite comprises an average Coulombic efficiency of >0.9999.

Embodiment 32. An electrode comprising a lithium carbon composite according to any of embodiments from Embodiment 1 to Embodiment 31.

Embodiment 33. An energy storage device comprising a lithium carbon composite according to any of embodiments from Embodiment 1 to Embodiment 31.

Embodiment 33. A lithium-carbon battery comprising a lithium carbon composite according to any of embodiments from Embodiment 1 to Embodiment 31.

Embodiment 34. A process for preparing lithium carbon composite particles, the process comprising:
a. providing a particulate porous carbon scaffold;
b. mixing the particulate porous carbon scaffold with lithium metal in the presence of an inert atmosphere;
c. heating the mixture at 180° C. to 1300° C. to melt the lithium metal and allow capillary forces to condense molten lithium within the pore structure of the carbon.

Embodiment 35. The process of Embodiment 34 where in the porous carbon particle comprise a Dv50 between 0.1 and 50 microns.

Embodiment 36. The process of any embodiment of Embodiment 34 to Embodiment 35 wherein the porous carbon particle comprises a pore volume greater than 0.5 cm³/g.

Embodiment 37. The process of any embodiment of Embodiment 34 to Embodiment 36 wherein the porous carbon scaffold comprises micropores and mesopores.

From the foregoing it will be appreciated that, although specific embodiments of the invention have been described herein for purposes of illustration, various modifications may be made without deviating from the spirit and scope of the invention. Accordingly, the invention is not limited except as by the appended claims.

U.S. Provisional Patent Application No. 63/280,491, filed Nov. 17, 2021, to which the present application claims priority, is hereby incorporated herein by reference in its entirety.

1. A lithium carbon composite, comprising:
a) a porous carbon scaffold comprising a pore volume; and
b) a lithium content of 30% to 70% by weight,
wherein the lithium resides within pores of the porous carbon scaffold.

2. The lithium carbon composite of claim 1, wherein a pore volume of the porous carbon scaffold is greater than 0.5 cm³/g.

3. The lithium carbon composite of claim 1, wherein the pore volume comprises micropores.

4. The lithium carbon composite of claim 1, further comprising a plurality of particles having a Dv50 between 0.1 and 50 microns.

5. The lithium carbon composite of claim 1, wherein a surface area of the lithium carbon composite is less than 30 m²/g.

6. The lithium carbon composite of claim 1, further comprising a +1 oxidation state occupying interstitial sites complexed with the carbon and forming different stoichiometries with lithium according to the formula LiₓC₆, wherein x=1 to 2.

7. The lithium carbon composite of claim 1, wherein a capacity of the lithium carbon composite is greater than 900 m²/g.

8. The lithium carbon composite of claim 1, wherein an average Coulombic efficiency of the lithium carbon composite is greater than 0.9970.

9. The lithium carbon composite of claim 1, further comprising a terminal particle coating which is a carbon coating.

10. The lithium carbon composite of claim 1, further comprising a terminal particle coating which is an ALD coating comprising an oxide comprising aluminum, zirconium, titanium, or combinations thereof.

11. A plurality of lithium carbon composite particles, comprising:
a) a carbon scaffold comprising:
i) micropores, and
ii) a pore volume of greater than 0.5 cm³/g; and
b) lithium residing within 10% to 90% of the carbon scaffold pore volume, wherein:
a lithium content of the lithium carbon composite particles is 30% to 70% by weight;
a Dv50 of the lithium carbon composite particles is between 0.1 and 50 microns; and
a surface area of the lithium carbon composite particles is less than 30 m²/g.

12. A plurality of lithium carbon composite particles, comprising:
a) a carbon scaffold comprising:
i) micropores, and;
ii) a pore volume of greater than 0.5 cm³/g;
b) lithium residing within 10% to 90% of the carbon scaffold pore volume; and
c) a terminal coating,
wherein:
a lithium content of the lithium carbon composite particles is 30% to 70% by weight;
a Dv50 of the lithium carbon composite particles is between 0.1 and 50 microns; and
a surface area of the lithium carbon composite particles is less than 30 m²/g.

13. An electrode comprising the lithium carbon composite particles of claim 11.

14. An electrode comprising the lithium carbon composite particles of claim 12.

15. The electrode of claim 13, further comprising at least one binder material and at least one carbon material.

16. The electrode of claim 15, wherein the at least one binder material is selected from a styrene-butadiene rubber sodium carboxymethylcellulose (SBR-Na-CMC), a polyvinylidene difluoride (PVDF), a polyimide (PI), a polyacrylic acid (PAA), and combinations thereof.

17. The electrode of claim 15, wherein the at least one carbon material is selected from a graphite, a graphene, a carbon conductive additive, Super P, Ketjenblack carbon, carbon nanotubes, carbon nanostructures, and combinations thereof.

18. A lithium carbon battery comprising the lithium carbon composite particles of claim 11.

19. A method of manufacturing a lithium carbon composite, the method comprising:
a) providing a particulate porous carbon scaffold;
b) mixing the particulate porous carbon scaffold with a solid lithium metal in the presence of an inert atmosphere to obtain a mixture;
c) heating the mixture at 180° C. to 1300° C. to melt the lithium metal; and
d) impregnating the molten lithium metal into pores of the particulate porous carbon scaffold particles.

20. A method of manufacturing a particulate lithium carbon composite material, the method comprising:
a) mixing polymer precursors and storing for a period of time at sufficient temperature to allow for polymerization of the polymer precursors to obtain a polymer material;
b) carbonizing the polymer material to create a porous carbon material comprising a pore volume of greater than 0.5 cm³/g;
c) comminuting the porous carbon material to create a plurality of porous carbon scaffold particles comprising a Dv50 between 0.1 and 50 microns;
d) mixing the porous carbon scaffold particles with solid lithium metal in the presence of an inert atmosphere to obtain a mixture;
e) heating the mixture at 180° C. to 1300° C. to melt the lithium metal; and
f) impregnating the molten lithium metal into pores of the porous carbon scaffold particles.

21. A method of manufacturing a lithium carbon composite, the method comprising:
a) providing a particulate porous carbon scaffold;
b) mixing the particulate porous carbon scaffold with solid lithium metal in the presence of an inert atmosphere to obtain a mixture;
c) heating the mixture at 180° C. to 1300° C. to melt the lithium metal;
d) impregnating the molten lithium metal into pores of the particulate porous carbon scaffold; and
e) heating the lithium impregnated particles in the presence of acetylene at 350° C. to 1050° C.

22. A method of manufacturing a particulate lithium carbon composite material, the method comprising:
a) mixing polymer precursors and storing for a period of time at sufficient temperature to allow for polymerization of the precursors to obtain a polymer material;
b) carbonizing the polymer material to create a porous carbon material comprising a pore volume of greater than 0.5 cm³/g;
c) comminuting the porous carbon material to create a plurality of porous carbon scaffold particles comprising a Dv50 between 0.1 and 50 microns;
d) mixing the porous carbon scaffold particles with solid lithium metal in the presence of an inert atmosphere to obtain a mixture;
e) heating the mixture at 180° C. to 1300° C. to melt the lithium metal;
f) impregnating the molten lithium metal into pores of the porous carbon scaffold particles; and
g) heating the lithium impregnated particles in the presence of acetylene at 350° C. to 1050° C.
